(19) United States
(12) Patent Application Publication
(10) Pub. No.: US 2025/0296867 A1
(43) Pub. Date: Sep. 25, 2025

(54) METHODS FOR FORMING AND TUNING LOCAL TRANSMITTANCE CONTRAST IN GLASS-CERAMIC ARTICLES VIA LASER BLEACHING

(71) Applicant: CORNING INCORPORATED, CORNING, NY (US)

(72) Inventors: Matthew John Dejneka, Corning, NY (US); Jesse Kohl, Horseheads, NY (US); Rohit Rai, Painted Post, NY (US); Alexander Mikhailovich Streltsov, Corning, NY (US)

(21) Appl. No.: 18/868,946

(22) PCT Filed: Jun. 6, 2023
(86) PCT No.: PCT/US2023/024535

§ 371 Date: Nov. 25, 2024

Related U.S. Application Data
(60) Provisional application No. 63/349,617, filed on Jun. 7, 2022.

(51) Int. Cl. C03B 33/08; C03B 25/02

(52) U.S. Cl. CPC C03B 33/082; C03B 25/02

(57) ABSTRACT

A method of bleaching a glass-ceramic article is disclosed. The method includes irradiating a first portion of a bulk of the glass-ceramic article by directing a beam from a laser into a thickness of the bulk to heat the first portion and form a first aperture therein. The bulk is configured to have an amorphous silicate glass phase. a crystalline phase. and a bulk transmittance. The first aperture is configured to have a first transmittance that is greater than the bulk transmittance at first wavelengths from about 350 nm to about 2500 nm. The beam from the laser is configured to include a bleaching wavelength selected from a laser wavelength band within which residual absorption persists in the aperture after the irradiating at the bleaching wavelength.

### CROSS-REFERENCE TO RELATED APPLICATION

This application claims the benefit of priority under 35 U.S.C. § 119 of U.S. Provisional Application No. 63/349,617 filed Jun. 7, 2022, the content of which is incorporated herein by reference in its entirety.

### FIELD

The present disclosure relates generally to glass ceramics. More specifically, the present disclosure relates to forming and tuning local transmittance contrast in glass ceramics using laser radiation.

### BACKGROUND

Some products require highly-transparent apertures to be optically separated or isolated from one another, for example, by an opaque material that is intermediate the apertures. In existing configurations, such optical separation can be achieved by precision machining both an opaque material and separate portions of a highly-transparent material that is different than the opaque material and then setting the highly-transparent material portions in the opaque material. However, the precision machining and setting of different materials to provide such optical separation can be complex and expensive. Accordingly, there is a need for a monolithic glass ceramic material configured to be bleached to provide one or more highly-transparent apertures in a bleached region of the material and high optical absorbance in an unbleached region of the material so as to optically isolate the aperture(s). It would be further advantageous to provide such optical separation within a predetermined range of wavelengths.

### SUMMARY

A first aspect of the present disclosure includes a method of bleaching a glass-ceramic article, comprising: irradiating a first portion of a bulk of the glass-ceramic article by directing a beam from a laser into a thickness of the bulk to heat the first portion and form a first aperture therein, the bulk having an amorphous silicate glass phase, a crystalline phase, and a bulk transmittance, the first aperture having a first transmittance that is greater than the bulk transmittance at first wavelengths from 350 nm to 2500 nm, the beam comprising a bleaching wavelength selected from a laser wavelength band within which residual absorption persists in the aperture after the irradiating at the bleaching wavelength.

A second aspect of the present disclosure includes a method according to the first aspect, wherein the laser wavelength band comprises at least two laser wavelength bands that are nonoverlapping.

A third aspect of the present disclosure includes a method according to the first aspect or the second aspect, wherein the laser wavelength band comprises a lower laser wavelength band that is adjacent to and/or overlapping a lower end of the first wavelengths.

A fourth aspect of the present disclosure includes a method according to any one of the first through third aspects, wherein the laser wavelength band comprises an upper laser wavelength band that is adjacent to and/or overlapping an upper end of the first wavelengths.

A fifth aspect of the present disclosure includes a method according to any one of the first through fourth aspects, wherein the residual absorption, in terms of transmittance, persists in the aperture after the irradiating in a range of from about 5%/mm to about 85%/mm within the laser wavelength band.

A sixth aspect of the present disclosure includes a method according to any one of the first through fifth aspects, wherein the crystalline phase comprises a species of MₓWO₃ where 0<x<1 and where M is an intercalated dopant cation.

A seventh aspect of the present disclosure includes a method according to the sixth aspect, wherein the species of MₓWO₃ corresponds to a primary absorptive species into which the bleaching wavelength couples during the irradiating.

An eighth aspect of the present disclosure includes a method according to the seventh aspect, wherein the bulk comprises a secondary absorptive species into which the bleaching wavelength couples during the irradiating, the secondary absorptive species differing from the primary absorptive species so as to provide the residual absorption.

A ninth aspect of the present disclosure includes a method according to the eighth aspect, wherein the secondary absorptive species comprises chemical hydroxyl groups.

A tenth aspect of the present disclosure includes a method according to the eighth aspect or the ninth aspect, wherein the secondary absorptive species comprises an ultraviolet (UV) absorption edge of the glass phase.

An eleventh aspect of the present disclosure includes a method according to any one of the eighth through tenth, wherein the secondary absorptive species comprises a dopant, the method further comprising doping the bulk with the dopant prior to the irradiating.

A twelfth aspect of the present disclosure includes a method according to the eleventh aspect, wherein the dopant comprises one or more of Ce, Er, Tb, Pr, Mn, Ti, Cu, Co, Ni, Fe, Cr, V, Ag, and Au in oxide or metallic form.

A thirteenth aspect of the present disclosure includes a method according to the eleventh aspect or the twelfth aspect, wherein the bulk comprises less than 2.5 mol % of the dopant selected from the group consisting of Ce, Er, Pr, Tb, and combinations thereof.

A fourteenth aspect of the present disclosure includes a method according to any one of the eleventh through thirteenth aspects, wherein the bulk comprises less than 0.5 mol % of the dopant selected from the group consisting of Mn, Ti, Cu, Co, Ni, Fe, Cr, V, Ag, Au, and combinations thereof.

A fifteenth aspect of the present disclosure includes a method according to any one of the sixth through fourteenth aspects, wherein the irradiating is configured to heat the first portion of the bulk to a dissolution temperature in which the species of MₓWO₃ of the crystalline phase substantially dissolves into the bulk.

A sixteenth aspect of the present disclosure includes a method according to the fifteenth aspect, wherein the dissolution temperature is greater than the liquidus temperature of the species of MₓWO₃.

A seventeenth aspect of the present disclosure includes a method according to the fifteenth aspect or the sixteenth aspect, wherein the dissolution temperature is in a range of from about 600° C. to about 1,100° C.

An eighteenth aspect of the present disclosure includes a method according to any one of the fifteenth through seventeenth aspects, wherein the dissolution temperature is in a range of from about 900° C. to about 1,100° C.

A nineteenth aspect of the present disclosure includes a method according to any one of the first through eighteenth aspects, wherein the directing the beam from the laser comprises adjusting a focus of the beam so as to not exceed a maximum temperature within the first portion of the bulk during the irradiating.

A twentieth aspect of the present disclosure includes a method according to any one of the first through nineteenth aspects, wherein the laser comprises a mid-infrared (IR) laser, the beam directed from the mid-IR laser using a plurality of laser parameters.

A twenty first aspect of the present disclosure includes a method according to the twentieth aspect, wherein the laser parameters comprise a laser power in a range of from about 17.5 W to about 39.0 W.

A twenty second aspect of the present disclosure includes a method according to the twentieth aspect, wherein the laser parameters comprise a laser power in a range of from about 25.0 W to about 30.0 W.

A twenty third aspect of the present disclosure includes a method according to any one of the twentieth through twenty second aspects, wherein the laser parameters comprise a beam spot size in a range of from about 0.20 mm to about 1.50 mm.

A twenty fourth aspect of the present disclosure includes a method according to any one of the twentieth through twenty second aspects, wherein the laser parameters comprise a beam spot size in a range of from about 0.40 mm to about 1.0 mm.

A twenty fifth aspect of the present disclosure includes a method according to any one of the twentieth through twenty fourth aspects, wherein the laser parameters comprise an exposure time in a range of from about 0.70 s to about 12.0 s.

A twenty sixth aspect of the present disclosure includes a method according to any one of the twentieth through twenty fourth aspects, wherein the laser parameters comprise an exposure time in a range of from about 0.40 s to about 8.0 s.

A twenty seventh aspect of the present disclosure includes a method according to any one of the twentieth through twenty sixth aspects, wherein the laser parameters are configured to form the first aperture with a target diameter.

A twenty eighth aspect of the present disclosure includes a method according to the twenty seventh aspect, wherein the target diameter is in a range of from about 0.2 mm to about 5 mm.

A twenty ninth aspect of the present disclosure includes a method according to any one of the first through twenty eighth aspects, wherein the irradiating further comprises irradiating a second portion of the bulk by directing the beam from the laser into the thickness of the bulk to heat the second portion and form a second aperture therein, the second aperture having a second transmittance that is greater than the bulk transmittance at the first wavelengths.

A thirtieth aspect of the present disclosure includes a method according to the twenty ninth aspect, wherein the second aperture is spaced from the first aperture.

A thirty first aspect of the present disclosure includes a method according to the twenty ninth aspect or the thirtieth aspect, wherein the irradiating to form the first aperture and the irradiating to form the second aperture occur simultaneously.

A thirty second aspect of the present disclosure includes a method according to the twenty ninth aspect or the thirtieth aspect, wherein the irradiating to form the first aperture and the irradiating to form the second aperture occur sequentially with a dwell time therebetween.

A thirty third aspect of the present disclosure includes a method according to any one of the twenty ninth through thirty second aspects, further comprising contacting a first heatsink portion to a first surface of the bulk that is configured to be irradiated, the first heatsink portion defining respective first thru holes through which the beam from the laser is directed or passes to form the first aperture and the second aperture in the bulk.

A thirty fourth aspect of the present disclosure includes a method according to the thirty third aspect, further comprising contacting a second heatsink portion to a second surface of the bulk that is opposite the first surface such that the first heatsink portion and the second heatsink portion sandwich the bulk therebetween.

A thirty fifth aspect of the present disclosure includes a method according to the thirty fourth aspect, wherein second heatsink portion defines respective second thru holes through which the beam from the laser is directed or passes to form the first aperture and the second aperture in the bulk.

A thirty sixth aspect of the present disclosure includes a method according to any one of the first through thirty fifth aspects, further comprising preheating the glass-ceramic article prior to the irradiating.

A thirty seventh aspect of the present disclosure includes a method according to the thirty sixth aspect, wherein the preheating comprises heating the glass-ceramic article to a preheat temperature in a range of from about 100° C. to about 600° C.

A thirty eighth aspect of the present disclosure includes a method according to the thirty sixth aspect, wherein the preheating comprises heating the glass-ceramic article to a preheat temperature in a range of from about 200° C. to about 575° C.

A thirty ninth aspect of the present disclosure includes a method according to the thirty sixth aspect, wherein the preheating comprises heating the glass-ceramic article to a preheat temperature in a range of from about 300° C. to about 500° C.

A fortieth aspect of the present disclosure includes a method according to any one of the first through thirty ninth aspects, further comprising annealing the glass-ceramic article by heating the glass-ceramic article to an annealing temperature.

A forty first aspect of the present disclosure includes a method according to the fortieth aspect, wherein the annealing temperature is outside of a threshold temperature so as to substantially maintain the first transmittance, and wherein the annealing further comprises: holding the annealing temperature for a first duration, and rapidly cooling the glass-ceramic article from the annealing temperature to room temperature at a cooling rate that is substantially greater than furnace rate.

A forty second aspect of the present disclosure includes a method according to the forty first aspect, wherein the first duration is approximately 12 hours.

A forty third aspect of the present disclosure includes a method according to the fortieth aspect, wherein the annealing temperature comprises a first annealing temperature and a second annealing temperature that is greater than the first annealing temperature, wherein the first annealing temperature and the second annealing temperature are outside of a threshold temperature so as to substantially maintain the first transmittance, and wherein the annealing further comprises: heating the first aperture to the first annealing temperature, heating the bulk to the second annealing temperature, gradually cooling the bulk to the first annealing temperature, and rapidly cooling the first aperture and the bulk from the first annealing temperature to room temperature at a cooling rate that is substantially greater than furnace rate.

A forty fourth aspect of the present disclosure includes a method according to the forty third aspect, wherein the heating the bulk to the second annealing temperature comprises using a heater plate to heat the bulk, the heater plate defining at least one thru hole that aligns with the first aperture.

A forty fifth aspect of the present disclosure includes a method according to the forty third aspect, wherein the heating the bulk to the second annealing temperature comprise using a mid-IR heater to heat the bulk.

A forty sixth aspect of the present disclosure includes a method according to the forty fourth aspect or the forty fifth aspect, wherein the first aperture is actively cooled via one or more of conduction and convection during the heating the bulk to the second annealing temperature.

A forty seventh aspect of the present disclosure includes a method according to any one of the forty first through forty sixth aspects, wherein the first transmittance is reduced by less than 5%/mm after the annealing.

A forty eighth aspect of the present disclosure includes a method according to the fortieth aspect, wherein the annealing further comprises setting the annealing temperature to a threshold temperature for a duration so as to reduce the first transmittance.

A forty ninth aspect of the present disclosure includes a method according to the fortieth aspect, wherein the annealing further comprises setting the annealing temperature to gradually pass through a threshold temperature so as to reduce the first transmittance.

A fiftieth aspect of the present disclosure includes a method according to the forty eighth aspect or the forty ninth aspect, wherein the first transmittance is reduced by at least 5%/mm after the annealing.

A fifty first aspect of the present disclosure includes a method according to any one of the forty first through fiftieth aspects, wherein the threshold temperature is in a range of from greater than about 460° C. to about 500° C.

A fifty second aspect of the present disclosure includes a method according to any one of the fortieth through fifty first aspects, further comprising ion exchanging the glass-ceramic article in a bath comprising sodium nitrate and/or potassium nitrate between a temperature of 360 and 450° C. for between 0.25 hours and 25 hours.

A fifty third aspect of the present disclosure includes a method according to the fifty second aspect, wherein a residual birefringence in the first aperture after the annealing and before the ion exchanging is less than about 200 nm/mm.

A fifty fourth aspect of the present disclosure includes a method according to any one of the first through fifty third aspects, wherein the first transmittance is selectable between about 1% greater than the bulk transmittance and a transmittance of about 91%/mm at the first wavelengths.

A fifty fifth aspect of the present disclosure includes a method according to any one of the twenty ninth through fifty fourth aspects, wherein the second transmittance is selectable between about 1% greater than the bulk transmittance and a transmittance of about 91%/mm at the first wavelengths.

A fifty sixth aspect of the present disclosure includes a method according to any one of the first through fifty fifth aspects, wherein the bulk transmittance is in a range of from about 0.001%/mm to about 1%/mm at the first wavelengths.

A fifty seventh aspect of the present disclosure includes a method according to any one of the first through fifty sixth aspects, wherein a ratio between the first transmittance and the bulk transmittance is at least 1.0×10⁵ within a ratio band that extends for 100 nm between wavelengths from about 350 nm to about 2,500 nm.

A fifty eighth aspect of the present disclosure includes a method according to the fifty seventh aspect, wherein the ratio band is centered about a wavelength of 450 nm.

A fifty ninth aspect of the present disclosure includes a method according to any one of the first through fifty sixth aspects, wherein a ratio between the first transmittance and the bulk transmittance is at least 8.0×10²⁶ within a ratio band that extends for 100 nm between wavelengths from about 350 nm to about 2,500 nm.

A sixtieth aspect of the present disclosure includes a method according to the fifty ninth aspect, wherein the ratio band is centered about a wavelength of 1340 nm.

### BRIEF DESCRIPTION OF THE DRAWINGS

FIG. 1 is a schematic perspective view of a glass-ceramic article with a plurality of transparent regions laser bleached into an opaque bulk of the article;

FIG. 2 is a schematic side view of the glass-ceramic article of FIG. 1 with laser-bleached transparent regions having different configurations;

FIG. 3 is an image of a protrusion that may form at a transparent region as a result of the laser bleaching;

FIG. 4 is an image of light projected through the protrusion of FIG. 3 to illustrate a focusing function of the protrusion;

FIG. 5 is a flow diagram illustrating a method of laser bleaching a glass-ceramic article, such as the articles of FIG. 1 and FIG. 2.

FIG. 6 is schematic side view of the glass-ceramic article of FIG. 1 with heatsink portions arranged on surfaces of the glass-ceramic article;

FIG. 7 is a plot of transmittance of a bleached region at a wavelength of 633 nm for different samples based on preheat temperature during laser bleaching in accordance with Example 1.

FIG. 8 are plots of transmittance of bleached and unbleached regions of a glass-ceramic article over a range of wavelengths with areas of residual absorption indicated to facilitate selection of a laser bleaching wavelength in accordance with Example 2;

FIG. 9 are plots of relative transmittance at different wavelengths and a plot of annealing temperature both against annealing time for a glass-ceramic sample according to one annealing cycle so as to illustrate a threshold temperature in accordance with Example 3;

FIG. 10 are plots of relative transmittance at different wavelengths and a plot of annealing temperature both against annealing time for a glass-ceramic article according to another annealing cycle so as to illustrate the threshold temperature in accordance with Example 3;

FIG. 11 are plots of temperature against annealing time for a glass-ceramic article to illustrate preferential heating of select portions of the glass-ceramic article in accordance with Example 3;

FIGS. 12A-12D are images and data acquired from one experiment to evaluate the influence of alkali cation identity in samples of glass-ceramic articles in accordance with Example 4;

FIG. 13A and FIG. 13B are images and data acquired from another experiment to evaluate the influence of alkali cation identity in samples of glass-ceramic articles in accordance with Example 4;

FIG. 14 are images acquired from an experiment to evaluate the influence of laser beam spot size on the quality of the transparent regions during laser bleaching;

FIG. 15 are plots illustrating the effect of laser beam exposure time and laser beam spot size on the size of the transparent regions during laser bleaching;

FIG. 16 is a magnified digital image of a sample with a bleached aperture in accordance with Example 6;

FIG. 17 is a plot of transmittance of a bleached aperture in a sample over a range of wavelengths in accordance with Example 6;

FIG. 18 is a plot of transmittance of an unbleached bulk glass in a sample over a range of wavelengths in accordance with Example 6;

FIG. 19 is a plot of transmittance of a bleached aperture in the sample of FIG. 18 in accordance with Example 6; and

FIG. 20 is a plot of a ratio of the transmittance of the bleached aperture in FIG. 19 and the transmittance of the bulk glass in FIG. 18 over the same range of wavelengths.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains

As used herein, the term “and/or,” when used in a list of two or more items, means thatany one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical valueor end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein, unless defined elsewhere in association with specific terms or phrases, are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom, above, below, and the like—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

For purposes of this disclosure, the terms “bulk,” “bulk composition,” and/or “overall compositions” are intended to include the overall composition of the entire article. These terms may be differentiated from a “local composition” or “localized composition,” which refers to a composition at a particular location, over a particular area, or over a particular volume on or within the article. The local composition may differ from the bulk composition owing, for example, to the formation of crystalline and/or ceramic phases. The bleached aperture(s) disclosed herein include local composition(s).

As used herein, the terms “article,” “glass-article,” “ceramic-article,” “glass-ceramics, “glass elements,” “glass-ceramic article,” and “glass-ceramic articles” may be used interchangeably, and in their broadest sense, to include any object made wholly or partly of glass and/or glass-ceramic material having a crystalline phase.

As used herein, a “glass” or “glass state” refers to an inorganic amorphous phase material within the articles of the disclosure that is a product of melt fusion that has cooled to a rigid condition without crystallizing. As used herein, a “glass-ceramic” or “glass-ceramic state” refers to an inorganic material within the articles of the disclosure which includes both the glass state and a crystalline phase and/or crystalline precipitates as described herein.

As used herein, “a crystalline phase” and/or “crystalline precipitates” refers to an inorganic material within the articles of the disclosure that is a solid composed of atoms, ions, or molecules arranged in a pattern that is periodic in three dimensions. Further, “a crystalline phase” as referenced in this disclosure, unless expressly noted otherwise, is determined to be present using the following method. First, powder x-ray diffraction (“XRD”) is employed to detect the presence of crystalline precipitates. Second, Raman spectroscopy (“Raman”) is employed to detect the presence of crystalline precipitates in the event that XRD is unsuccessful (e.g., due to size, quantity and/or chemistry of the precipitates). Optionally, transmission electron microscopy (“TEM”) is employed to visually confirm or otherwise substantiate the determination of crystalline precipitates obtained through the XRD and/or Raman techniques. In certain circumstances, the quantity and/or size of the precipitates may be low enough that visual confirmation of the precipitates proves particularly difficult. As such, the larger sample size of XRD and Raman may be advantageous in sampling a greater quantity of material to determine the presence of the precipitates.

As used herein, “transmission,” “transmittance,” “optical transmittance,” and “total transmittance” are used interchangeably in the disclosure and refer to external transmission or transmittance, which takes absorption, scattering, and reflection into consideration. Fresnel reflection is not subtracted out of the transmission and transmittance values reported herein. Transmittance values referenced over a particular wavelength range are given as an average of the total transmittance values measured over the specified wavelength range. Transmittance (T) is defined as the ratio of the transmitted intensity (I) over the incident intensity (I₀) and is given by the equation T=I/I₀. Transmittance takes values between 0 and 1 though it is often expressed as a percentage out of one-hundred. Transmittance is measured with a spectrometer.

As used herein, “optical density units,” “optical density,” “OD,” and “OD units” are used interchangeably in the disclosure to refer to optical density units, as commonly understood as a measure of “absorbance” of the material tested, as measured with a spectrometer. Absorbance values referenced over a particular wavelength range (e.g., UV wavelengths from 280 nm to 380 nm) are given as an average value of the absorbance over the specified wavelength range. Absorbance (A) is related to the transmittance, transmitted intensity, and incident intensity by the equation A=log₁₀* I₀/I=−log₁₀*T. For example, an absorbance of 0 corresponds to a transmittance of 100% whereas an absorbance of 1 corresponds to 10% transmittance. Unless otherwise specified, transmittance and absorbance are measured using the PerkinElmer Lambda 950 UV-VIS-NIR Spectrophotometer, which is a commercially available spectrometer.

The present disclosure relates generally to articles that have one or more transparent regions (bleached into) or formed within a monolithic material that is highly opaque at visible and near infrared (NIR) wavelengths and methods of forming such regions. Specifically, the high opacity in this disclosure is achieved with high absorption which is superior to opaque scattering materials. The transparent regions in embodiments can include one or more apertures, louvers, or any similarly transparent optical path or passage configured to permit light to be transmitted through the highly opaque material at a higher transmittance or a substantially higher transmittance than transmitted through the highly opaque material. One of skill in the art will recognize that the transparent regions applied to the article may take many forms without departing from the concepts disclosed herein. The highly opaque monolithic material in embodiments is configured to optically isolate the one or more transparent regions with a high absorbance at a minimum path length.

In various examples of the present disclosure, an article that is bleached can be a glass-ceramic article. The article that is bleached can be a tungsten, molybdenum, titanium, and/or magnesium containing glass ceramic, such as those disclosed in U.S. Pat. No. 10,246,371 entitled ARTICLES INCLUDING GLASS AND/OR GLASS-CERAMICS AND METHODS OF MAKING THE SAME, U.S. Pat. No. 10,370,291 entitled ARTICLES INCLUDING GLASS AND/OR GLASS-CERAMICS AND METHODS OF MAKING THE SAME, U.S. Pat. No. 10,450,220 entitled GLASS-CERAMICS AND GLASSES, U.S. Patent Application Publication No. 2019/0177206 (Ser. No. 16/190,712) entitled POLYCHROMATIC ARTICLES AND METHODS OF MAKING THE SAME, International Application Publication No. WO 2019/051408 entitled DEVICES WITH BLEACHED DISCRETE REGION AND METHODS OF MANUFACTURE, and U.S. patent application Ser. No. 17/183,539, filed Feb. 24, 2021 and entitled LOW TEMPERATURE LASER BLEACHING OF POLYCHROMATIC GLASS CERAMICS, the content of each of which is incorporated herein by reference in its entirety.

In general, the crystalline phases formed by heat treating the compositions of the articles (prior to bleaching) described herein may be referred to as sub-oxides. Tungsten bronzes are examples of sub-oxides in that such crystals have a non-stoichiometric ratio of dopants to tungsten ions. Crystalline structures that are present in the glass-ceramic articles of the present disclosure are capable of undergoing changes in oxidation state and changes in dopant concentration as a result of one or more heating processes applied during manufacture to effect various colors and/or color profiles for the glass-ceramic article. Similarly, the oxidation state and/or the dopant concentration of the crystalline structures of the present disclosure may be altered by the bleaching processes disclosed herein. The changes in dopant concentration also affects absorbance of the compositions in the ultraviolet (UV), visible, and near infrared (NIR) wavelength regimes. In various examples, changes in the crystal structure, changes in stoichiometry, and/or changes in oxidation state induced by the beam from the laser may be accompanied by re-solubilization of the crystals such that the crystals are dissolved into the glass matrix. The traits of the crystalline structure of the glass-ceramic article have allowed the glass-ceramic articles of the present disclosure to bleach at relatively low temperatures.

The composition of the glass-ceramic article can be designed for a particular forming process (e.g., fusion forming, pressing, casting, etc.) and the glass-ceramic article can be subsequently processed with heat treatment(s) to adjust or tune a color and/or a saturation level or absorbance of the glass-ceramic article to a desired color and/or saturation level. Regardless of the approach or method utilized in the formation of the glass-ceramic article, the glass-ceramic article can be bleached by the techniques disclosed herein. The glass transition temperature, T_{g}, of the glass-ceramic articles bleached by the process of the present disclosure differ from one another. However, the glass transition temperatures of each of the various compositions are in the range of about 400° C. to about 600° C.

“Glass transition temperature” is defined herein as the temperature at which a glass, or glass portion of a glass ceramic, has a viscosity of 10¹² Poise. “Annealing point” or “annealing temperature” is defined herein as the temperature at which a glass, or glass portion of a glass ceramic, has a viscosity of 10¹³ Poise. “Softening point” or “softening temperature” is defined herein as the temperature at which a glass, or glass portion of a glass ceramic, has a viscosity of 10^{7.6} Poise. When cooling of the article is uniform, the glass transition temperature or annealing temperature may be approximately the same throughout the article. However, in the event that cooling in one portion of the article differed from the cooling in another portion of the article, then the glass transition temperature or the annealing temperature may be different in the portions with differing cooling rates or cooling histories. Local fluctuations in glass composition can also lead to slight variations in glass transition temperature or annealing temperature.

The desired color and/or saturation level or absorbance of the glass-ceramic article can have an impact on a final contrast ratio of the bleached region formed in the glass-ceramic article. The methods disclosed herein are capable of bleaching the glass-ceramic article such that the region that is bleached is transparent or substantially transparent in a given wavelength range (e.g., one or more wavelengths of the visible spectrum from about 380 nm to 740 nm). Accordingly, glass-ceramic articles that are produced with a greater saturation level may exhibit a greater resulting contrast ratio than glass-ceramic articles that are produced with a lower saturation level. While a selective application of one or more heating processes can be utilized to adjust the color and/or saturation level of the glass-ceramic article during manufacture, the local heating process disclosed herein (e.g., laser bleaching) that is used for bleaching the article may reverse the one or more heating processes to remove the color and/or decrease the saturation level in the regions that are bleached. Accordingly, the color or other property of the article may be altered in a region that has been bleached. Examples of physical and chemical properties that are altered by interaction with the beam from the laser can include, but are not limited to, oxidation state, coordination number, structural phase, mechanical properties (e.g., local density and/or local stress), crystallinity, percent crystallinity, and/or thermal properties (e.g., T_{g}, fictive temperature, and/or specific heat).

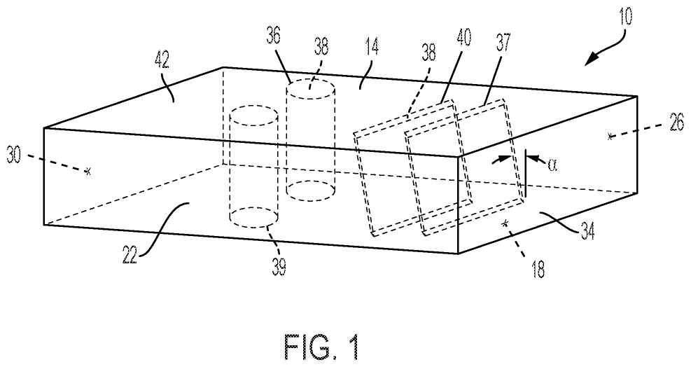

With reference to FIG. 1, a glass-ceramic article 10 is depicted. The article 10 has a thickness, a width, and a length. The thickness extends between a top surface 14 and a bottom surface 18 of the article 10. The width extends between a front surface 22 and a rear surface 26 of the article 10. The length extends between side surfaces 30, 34 of the article 10. In embodiments, the article 10 has a thickness in a range of from about 0.100 mm to about 3.750 mm, or from about 0.050 mm to about 4.875 mm, or from about 0.090 mm to about 6.0 mm, or from about 0.050 mm to about 7.125 mm, or from about 0.080 mm to about 8.25 mm, or from about 0.050 mm to about 9.375 mm, or from about 0.070 mm to about 10.5 mm, or from about 0.050 mm to about 11.625 mm, or from about 0.060 mm to about 12.75 mm, or from about 0.050 mm to about 13.875 mm, or from about 0.185 mm to about 15.0 mm, or from about 0.155 mm to about 15.0 mm, or from about 0.125 mm to about 15.0 mm, or from about 0.095 mm to about 15.0 mm, or from about 0.065 mm to about 15.0 mm, or from about 0.050 mm to about 15.0 mm, and all thickness values between these thickness range endpoints. Further, the article 10 can have a selected length and width, or diameter, to define its surface area. The article 10 can have at least one edge between the surfaces 14, 18 of the substrate 10 defined by its length and width, or diameter.

A first bleached region 36 is illustrated in phantom lines in exemplary form and is shown as a cylindrical aperture. The first bleached region 36 can extend through an entirety of the thickness in a direction parallel to the thickness. The first bleached region 36 can have a resolution that is the same or substantially the same through the entirety of the extent to which the first bleached region 36 extends through the thickness. That is, a resolution of the first bleached region 36 can be the same or substantially same at a portion of the first bleached region 36 that is proximate to the top surface 14, at a portion of the first bleached region 36 that is proximate to the bottom surface 18, and at a portion of the first bleached region 36 that is positioned intermediate the top surface 14 and the bottom surface 18.

A second bleached region 37 is illustrated in phantom lines in exemplary form and is shown as a slit or louver in the article 10. The second bleached region 37 can extend through an entirety of the thickness. Similar to the first bleached region 36, the second bleached region 37 can have a resolution that is the same or substantially the same through the entirety of the extent to which the second bleached region 37 extends through the thickness. The second bleached region 37 in embodiments can be oriented at an angle a relative to the surfaces between which it extends as shown in FIG. 1. The angle a in embodiments can be between 0.1° and arcsin(1/n), where n is the refractive index, relative to the direction of the thickness. For n=1.45, arcsin(1/n)=43.6°. In embodiments, the article 10 can include the first bleached region 36, the second bleached region 37, or both the first bleached region 36 and the second bleached region 37. The article 10 in embodiments can include any number of additional bleached regions. The first bleached region 36, the second bleached region, and any additional bleached regions can have any number, geometry, angle, and/or orientation desired. In embodiments, the bleached regions can be substantially duplicated, for example, two first bleached regions 36, 39 and/or two second bleached regions 37, 40. The bleached regions can have a minimum spacing therebetween. The minimum spacing in embodiments can be at least 0.5 mm. In other embodiments, the minimum spacing between bleached regions can be 1 mm or greater. In some embodiments the spacing between bleached regions or lines can vary from about 0.5 mm to about 10 mm.

The first bleached region 36, the second bleached region 37, and/or any number of additional bleached regions can define one or more apertures in or through the article 10. As used herein, “aperture” refers to an integral portion of the article through which light travels with a higher transmittance or substantially higher transmittance than through unbleached regions of the article 10. In embodiments, an aperture cross-section can be non-polygonal shape, such as round, elliptical, oval, or stadium, polygonal shape, such as rectangular, square, or triangular, or any suitable geometric shape. In embodiments in which the aperture is formed through the thickness of a material defined by a first surface and a second surface, as described above, the aperture can have a cross-sectional dimension that is the same through the thickness of the material or different through the thickness of the material. As a non-limiting example, for an aperture that is circular in cross-section, the aperture can be cylindrical and have the same cross-sectional diameter at the first surface and second surface of the material. In embodiments, the aperture cross-sectional dimension is larger at the first surface of the material than at the second surface of the material. For example, the aperture can be conical in shape.

In embodiments, the aperture can be formed through a portion of the thickness of the glass-ceramic article as opposed to formed through an entirety of the thickness. For example, the aperture can extend through at least 5%, at least 10%, at least 20%, at least 30%, or at least 40%, or at least 45% of the thickness of the glass-ceramic article. The aperture in embodiments can extend through at most 55%, at most 60%, at most 70%, at most 80%, at most 90%, or at most 95% of the thickness of the glass-ceramic article.

The term “diameter” is not limited to a circular shape in embodiments disclosed herein. Thus, “diameter” in embodiments can refer to a distance between edges of an aperture which can be square, rectangular, polygonal, or any suitable geometric shape for a particular end use. For apertures that are polygonal, the diameter refers to a straight line passing from side to side through the center of the aperture. In the case of a rectangle, the diameter refers to the smallest cross-sectional dimension of the rectangle. In the case of a triangle, the diameter refers to the smallest height of the triangle. In the case of an elliptical aperture, the diameter refers to the smallest cross-sectional dimension passing through the center of the ellipse.

The bleached regions in embodiments comprise a plurality of apertures with each aperture having a diameter in a range of from about 10 μm to about 100,000 μm, or in a range of from about 10 μm to about 10,000 μm, or in a range of from about 10 μm to about 5,000 μm, or in a range of from about 10 μm to about 1,000 μm, or in a range of from about 10 μm to about 500 μm, or in a range of from about 50 μm to about 10,000 μm, or in a range of from about 50 μm to about 5,000 μm or in a range of from about 50 μm to about 1,000 μm, or in a range of from about 50 μm to about 500 μm, or in a range of from about 50 μm to about 300 μm, or in a range of from about 50 μm to about 200 μm, or in a range of from about 50 μm to about 100 μm, or in a range of from about 10 μm to about 90 μm, or in a range of from about 10 μm to about 80 μm, or in a range of from about 10 μm to about 70 μm, or in a range of from about 10 μm to about 60 μm, or in a range of from about 10 μm to about 50 μm. In embodiments, the apertures have a center-to-center spacing in a range of from about 20 μm to about 200 μm or from 20 μm to about 100 μm.

A first portion 38 of the article 10 is a portion of the article 10 that has been bleached as a result of the interaction between the article 10 and the beam from the laser. A second portion 42 of the article 10 is a region of the article that has not been exposed to the beam from the laser. The first portion 38 and the second portion 42 are sometimes referred to herein as a bleached region and an unbleached region, respectively. It will be understood that, while the article 10 is depicted in FIG. 1 as a rectangular substrate, the present disclosure is not so limited. Rather, the article 10 may be contoured such that one or more of the top surface 14, the bottom surface 18, the front surface 22, the rear surface 26, the side surface 30, and the side surface 34 are provided with inflection point(s), undulations, bevels, curvature, and/or other perturbations such that a given one of the surfaces may not lie entirely along a single plane.

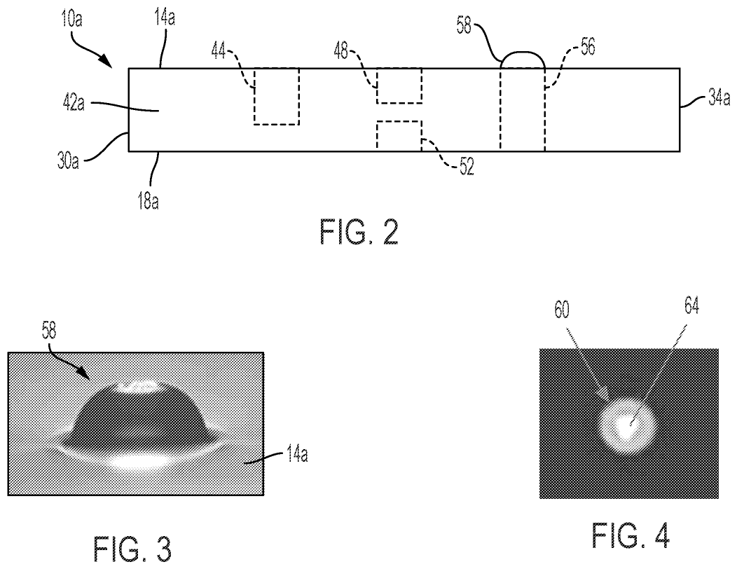

Referring now to FIG. 2, a glass-ceramic article 10a is depicted. The glass-ceramic article 10a of FIG. 2 is similar to the glass-ceramic article 10 of FIG. 1 except with regard to the configuration of the bleached regions or apertures formed therein. In FIG. 2, features of the glass-ceramic article 10a that are substantially similar to features of the glass-ceramic article 10 of FIG. 1 use like reference numerals appended by “a”. The glass-ceramic article 10a includes a first aperture 44, a second aperture 48, a third aperture 52, and a fourth aperture 56 formed in the bulk 42b. The first aperture 44, the second aperture 48, and the third aperture 52 are formed through a portion of the thickness of the glass-ceramic article 10a instead of formed through the entirety of the thickness. For instance, the first aperture 44 is formed through approximately 60% of the thickness of the glass-ceramic article 10a, and the second aperture 48 and the third aperture are each formed through approximately 40% of the thickness of the glass-ceramic article 10a.

The apertures, when formed through a portion of the thickness of the glass-ceramic article such as shown in FIG. 2, may adjoin only one surface of the glass-ceramic article. For instance, the first aperture 44 and the second aperture 48 each adjoin the top surface 14a whereas the third aperture 52 adjoins the bottom surface 18a. In embodiments, apertures formed through a portion of the thickness and adjoining different or opposite surfaces can be aligned so as to be colinearly arranged through the thickness or arranged to have at least some overlap when viewed in a direction of extent, such as the second aperture 48 and the third aperture 52 shown in FIG. 2. In embodiments, the second aperture 48 and the third aperture 52 can be formed from different or opposite surfaces but with respective lengths sufficient for the second aperture 48 and the third aperture 52 to intersect so as to form or essentially form a single aperture. Such embodiments that include a single aperture comprised of respective aperture portions formed from different or opposite sides can be useful when forming bleached regions in a glass-ceramic article that is relatively thick.

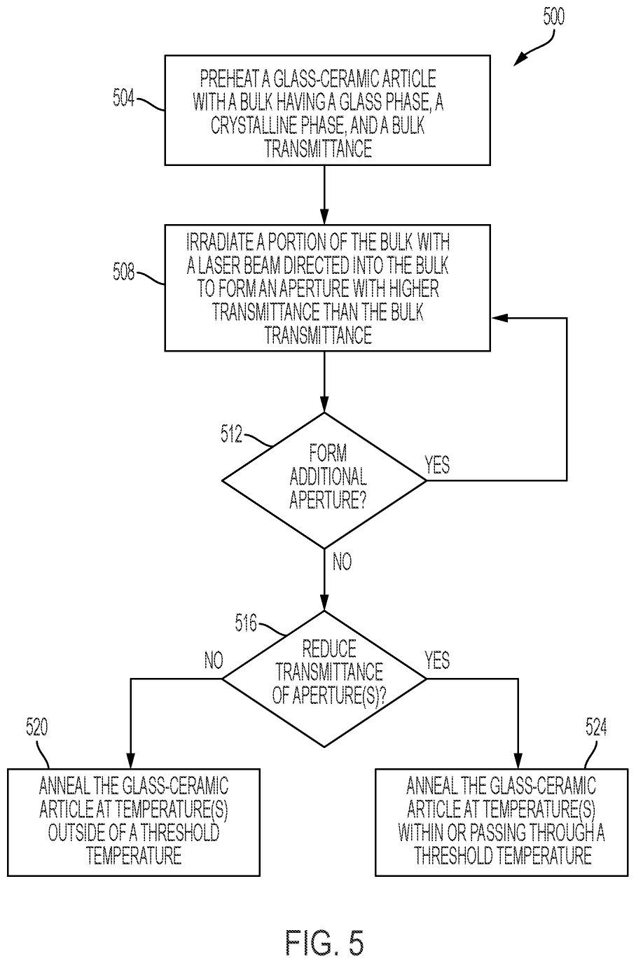

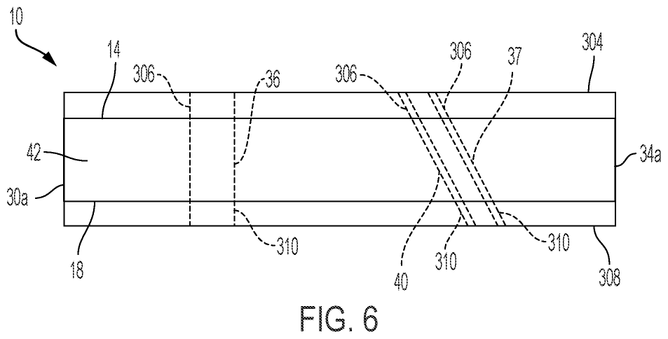

The apertures in embodiments can include a protrusion or bump at the surface through which the apertures are formed in the glass-ceramic article. For instance, the fourth aperture 56a in the glass-ceramic article 10a of FIG. 2 includes a protrusion 58 that protrudes from the top surface 14a. During the bleaching process, as discussed later in this disclosure, the glass that is exposed to the laser can swell as it is heated. This swelling can result in the formation of the protrusion 58. FIG. 3 is an enlarged image of a protrusion 58 that protrudes from an aperture formed in a glass-ceramic article prepared according to the methods disclosed herein. The protrusion 58 can function as a lens that focuses light, which can be useful in various applications, such as a cover for a detector or sensor. FIG. 4 is an image of light transmitted through a protrusion of an aperture formed in a glass-ceramic article, such as the protrusion 58 of FIGS. 2 and 3, with the light projected onto a surface that is spaced from the glass-ceramic article. As shown in FIG. 4, a projected light image 60 includes a bright spot 64 within the center of the projection light image, demonstrating that the protrusion 58 can function as focusing optics. By varying laser parameters, as discussed later in this disclosure, the geometry and/or shape of the protrusion 58 can be varied to alter the numerical aperture of the lens. In embodiments, post-processing of the protrusion 58 via grinding/polishing/CNC machining can further alter the geometry and/or shape of the protrusion to vary its focusing properties.

In embodiments, the glass-ceramic article can include bleached patterns formed by the plurality of apertures. For instance, bleached lines and or other patterns can be formed by bleaching a series of spots or apertures near to each other or with partially overlapping spots to form a design. This patterning process is analogous to a drawing comprised of pixels and is similar to the painting technique called pointillism in which an image is formed with spots of different colors. In a similar manner, the patterning or formation of bleached shapes can be achieved by shaping the laser beam. Such techniques combined with partial or complete bleaching, as discussed later in this disclosure, enables images and patterns to be formed with varying levels of transmittance or shading. By partially bleaching the bleached regions in a sample such that the transmittance of the bleached regions is slightly higher than the unbleached region, bleached features or patterns can be effectively hidden until the sample is backlit to reveal them. This concept is sometimes referred to as “dead-fronting”.

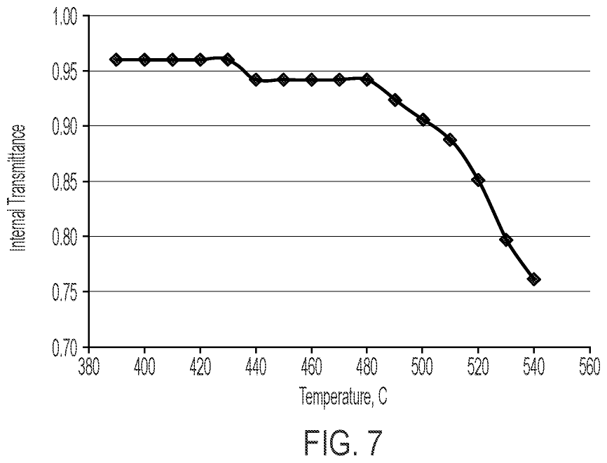

With reference to FIG. 5, a method 500 of bleaching a glass-ceramic article, such as the glass-ceramic article 10 of FIG. 1 and the glass-ceramic article 10a of FIG. 2, can include preheating the glass-ceramic article. (Block 504) The glass-ceramic article comprises a bulk having an amorphous silicate glass phase, a crystalline phase, and a bulk transmittance. The crystalline phase in embodiments includes a species of MₓWO₃ where 0<x<1 and M is an intercalated dopant cation, such as one or more of H, Li, Na, K, Rb, Cs, Ca, Sr, Ba, Zn, Ag, Au, Cu, Sn, Cd, In, Tl, Pb, Bi, Th, La, Pr, Nd, Sm, Eu, Gd, Dy, Ho, Er, Tm, Yb, Lu, U, Ti, V, Cr, Mn, Fe, Ni, Pd, Se, Ta, and/or Ce. In embodiments, the preheating can take place before other steps of the method 500. It has been observed that the temperature at which the glass-ceramic article is maintained during bleaching can influence the resulting transmittance achieved by the bleaching, as illustrated in connection with Example 1 discussed later in this disclosure. In embodiments, the preheating comprises heating the glass-ceramic article to a preheat temperature in a range of from about 100° C. to about 600° C., or from about 200° C. to about 575° C., or from about 300° C. to about 500° C., and also comprising all sub-ranges and sub-values between these range endpoints.

The method 500 further includes irradiating a first portion of the bulk of the glass-ceramic article by directing a beam from a laser into a thickness of the bulk to heat the first portion and form a first aperture, such as the first bleached region 36 and/or the second bleached region 37 of FIG. 1, in the bulk. (Block 508). After the irradiating, the first aperture has a first transmittance that is greater or higher than the bulk transmittance at first wavelengths in a given range, such as from about 350 nm to about 2500 nm, or other ranges as discussed later in this disclosure. In embodiments, the bulk transmittance is in a range of from about 0.001%/mm to about 1%/mm at the first wavelengths though other ranges are contemplated as discussed later in this disclosure. In embodiments, the beam comprises a bleaching wavelength selected from a laser wavelength band within which residual absorption persists in the aperture after the irradiating at the bleaching wavelength.

As used herein, the term “residual absorption” refers to absorption capacity that remains in the aperture within one or more laser wavelength bands after the irradiating at the bleaching wavelength. The persistence of such residual absorption after the irradiating ensures there is sufficient absorption during the irradiating to heat the irradiated portion to a sufficient temperature (referred to interchangeably hereinafter as a dissolution temperature) such that constituents of the crystalline phase (e.g., the species of the MₓWO₃) are significantly, substantially, and/or fully dissolved into the bulk. In embodiments, the residual absorption, in terms of transmittance, persists in the aperture after the irradiating in a range of from about 5%/mm to about 85%/mm (or an absorbance in a range of from about 1.3/mm to a about 0.071/mm), or from about 10%/mm to about 85%/mm (or an absorbance in a range of from about 1.0/mm to about 0.071/mm), or from about 10%/mm to about 80%/mm (or an absorbance in a range of from about 1.0/mm to about 0.097/mm), or from about 10%/mm to about 70%/mm (or an absorbance in a range of from about 1.0/mm to about 0.155/mm), or from about 15%/mm to about 75%/mm (or an absorbance in a range of from about 0.824/mm to about 0.125/mm), or from about 5%/mm to about 70%/mm (or an absorbance in a range of from about 1.3/mm to about 0.155/mm), or from about 5%/mm to about 60%/mm (or an absorbance in a range of from about 1.3/mm to about 0.222/mm), and also comprising all sub-ranges and sub-values between these range endpoints, within the one or more laser wavelength bands.

In embodiments, the laser wavelength band from which the bleaching wavelength is selected comprises at least two laser wavelength bands that are spaced apart such that the at least two laser wavelength bands do not overlap. In embodiments, the at least two laser wavelength bands are spaced apart at opposite ends of the range of the first wavelengths. For instance, one of the at least two laser wavelength bands comprises a lower laser wavelength band that is less than the first wavelengths, and another one of the at least two laser wavelength bands comprises an upper laser wavelength band that is greater than the first wavelengths. In embodiments, the lower laser wavelength band is adjacent to and/or overlapping a lower end of the first wavelengths. In embodiments, the upper laser wavelength band is adjacent to and/or overlapping an upper end of the first wavelengths. The determination of a laser wavelength band within which residual absorption persists in the aperture after the irradiating at the bleaching wavelength is illustrated in connection with Example 2 discussed later in this disclosure.

The bleaching wavelength is configured to couple into the absorption or absorption bands of different absorptive species within the bulk of the glass-ceramic article in order to heat the irradiated portion of the bulk to the dissolution temperature. In embodiments, the species of MₓWO₃ of the crystalline phase corresponds to a primary absorptive species into which the bleaching wavelength couples during the irradiating. In embodiments, the bulk comprises a secondary absorptive species into which the bleaching wavelength couples during the irradiating. The secondary absorptive species differs from the primary absorptive species so as to provide the residual absorption. In embodiments, the secondary absorptive species comprises chemical hydroxyl groups (i.e., OH groups) in the bulk that can absorb in regions of the infrared (IR) spectrum. In embodiments, the secondary absorptive species comprises an ultraviolet (UV) absorption edge of the amorphous silicate glass phase in the bulk that can absorb in regions of the UV spectrum.

In embodiments, the secondary absorptive species comprises a dopant that is configured to absorb during the irradiating at the bleaching wavelength. In such embodiments, the method 500 further comprises doping the bulk with the dopant prior to the irradiating. In embodiments, the dopant comprises one or more of Ce, Er, Tb, Pr, Mn, Ti, Cu, Co, Ni, Fe, Cr, V, Ag, and Au in oxide or metallic form. In embodiments, the bulk comprises less than 2.5 mol % of the dopant selected from the group consisting of Ce, Er, Pr, Tb, and combinations thereof (i.e., rare earth dopants). In embodiments, the bulk comprises less than 0.5 mol % of the dopant selected from the group consisting of Mn, Ti, Cu, Co, Ni, Fe, Cr, V, Ag, Au, and combinations thereof. In embodiments, the secondary absorptive species can include other absorbing species, including transient absorbing species.

According to embodiments, the glass-ceramic article is processed in a way to optically bleach at least one discrete region in the article. The laser bleaching of the glass-ceramic article can occur due to a number of mechanisms or processes.

In absorbing glass-ceramic materials, such as the glass-ceramic compositions disclosed herein, the oxidation state of an ion (e.g., metal ion or ion complex such as tungstate or molybdate) can be altered by the laser bleaching. The ion can directly absorb the laser energy and change oxidation state, or it can undergo a change in oxidation due to absorption by another constituent of the glass-ceramic and interaction (e.g., thermally or via electron transfer) with the absorbing constituent. For example, the laser bleaching can initiate a redox reaction where an absorbing ion (e.g., a metal ion) is either oxidized or reduced from an absorbing or colored ion to a colorless or less intensely colored ion within a given wavelength spectrum (e.g., the visible spectrum). In various examples, the beam from the laser can be absorbed by the second absorptive species (e.g., chemical hydroxyl groups, the UV absorption edge of the glass phase, and/or one or more dopants with absorption at the laser wavelength) within the glass-ceramic article, which in turn leads to a thermal event that causes or initiates a redox reaction between tungsten and/or other multivalent species in the glass-ceramic article that can donate and/or accept electrons from other components present in the glass-ceramic article (e.g., SnO₂). It is noted that some crystals of the type MₓWO₃, which is discussed further herein, may absorb at the wavelength of the laser beam. In such instances, the MₓWO₃ crystals may absorb energy from the laser beam, heat as a result of the energy absorption, and cause decomposition of the crystal, thereby resulting in alkali de-intercalation from the crystal and dissolution of the alkali into the glass. In some examples, the glass-ceramic article can experience an electron trapping effect as a result of the interaction of the laser beam with the glass-ceramic article in which electron capture by the absorbing ion or electron transfer from the absorbing ion leads to a change in oxidation state that increases optical transmittance within the given wavelength range in the region exposed to the beam of the laser.

In absorbing glass-ceramic materials that include at least one cation in a crystalline phase, bleaching can occur through a process of cation de-intercalation. In the cation de-intercalation process, the cation can be liberated from the crystals of the glass-ceramic article, thereby leaving behind an oxidized metal oxide (e.g., tungsten oxide) in regions of the glass-ceramic article that have been bleached. The de-intercalated cation in embodiments can also undergo a change in oxidation state.

In absorbing glass-ceramic materials, upon exposure to the beam from the laser, the crystals within the glass-ceramic article that are within the path of the laser beam can be obliterated such that constituents of the crystals are dissolved back into the glass, thereby resulting in dissolution of the crystals, which may be referred to as crystal amorphization or vitrification.

Absorbing glass-ceramic materials can be bleached by exposing the glass-ceramic material to thermal energy. For example, the laser bleaching disclosed herein can provide the thermal energy for forming bleached regions in a glass-ceramic material. It is possible to accomplish laser-induced bleaching by locally heating the bulk to a dissolution temperature in which the species of MₓWO₃ of the crystalline phase significantly, substantially, and/or fully dissolves into the bulk. In embodiment, the dissolution temperature is greater than the liquidus temperature of the species of MₓWO₃. In embodiments, the dissolution temperature is in a range of from about 600° C. to about 1,100° C., or from about 900° C. to about 1,100° C., or from about 650° C. to about 1,050° C., or from about 700° C. to about 1,000° C., or from about 800° C. to about 1,150° C., and also comprising all sub-ranges and sub-values between these range endpoints. Heating the bulk to the dissolution temperature causes the irradiated/heated portion of the bulk to become transparent and/or have a transmittance that is higher and/or substantially higher than the transmittance of the bulk. Such heating to the dissolution temperature can obliterate or remelt the crystals within the path of the laser beam and thereby return the constituents of the crystals to the bulk.

It has been observed that if the glass-ceramic article is exposed to a laser wavelength that is exclusively absorbed by the tungsten bronze crystals (e.g., the species of MₓWO₃ of the crystalline phase), the resultant heating causes the alkali cations to de-intercalate from the crystals and return to the glass matrix, leaving only stoichiometric tungsten oxide phase. Since this phase does not strongly absorb visible or near-IR wavelengths, the temperature of the article decreases even with prolonged laser exposure. During cooling some of the alkali leaves the glass and returns back to the crystal, resulting in re-development of absorbance and a reduction in transmittance. To fully dissolve the crystals back into the glass, the heating is configured to achieve a temperature above the liquidus temperature of the crystals (e.g., the dissolution temperature) for an appropriate amount of time. Thus, to enable substantial and/or complete dissolution of the crystals using laser exposure, the laser wavelength should be attenuated by the secondary absorptive species within the glass so that the glass continues to heat during the laser exposure.

In absorbing glass-ceramic materials, the bleaching can also occur when glass-ceramic is converted into glass by rapid heating and cooling, including when the temperature of the region or portion exposed to the beam of the laser is less than the dissolution temperature. The rapid heating and cooling can be accomplished by exposing the glass-ceramic to a beam from a laser for a time frame that is sufficiently long to convert the glass-ceramic into glass, but sufficiently short to maintain a local temperature at the point of heating to a temperature below the dissolution temperature. For example, localized thermal heating to a localized temperature by one or more laser radiation sources can be used to dissolve or re-solubilize (e.g., through remelting) various small crystalline phases (e.g., crystallites, micrometer-sized crystals (10 μm or less in cross-sectional dimension) or nanometer-sized crystals (100 nm or less in cross-sectional dimension)) in discrete localized regions of glass or glass-ceramic substrates exposed to the beam of the laser.

While the present disclosure is not to be limited by a scientific principle or theory, in embodiments, localized heating of discrete regions of substrates to a localized temperature in excess of the global temperature results in a reversible redox reaction within the glass or glass-ceramic material that erases (e.g., dissociates, decomposes, solubilizes, or otherwise eliminates) a chromophore(s) in the form of small crystals that gives rise to visible absorbance. The term “global temperature,” as used herein, is intended to refer to a bulk or average temperature of the glass-ceramic article as measured at a location on the glass-ceramic article that is remote from a region of the glass-ceramic article that is being actively bleached with the beam from the laser. When the chromophores are erased, absorbance is reduced in the substrate, and average external optical transmittance is increased. In embodiments, the rate of heating or cooling can be varied by varying the power or degree of focusing of a continuous wave (CW) laser, or by varying the time of exposure of the glass-ceramic article to the laser beam.

The bleaching can be achieved using any suitable apparatus or system to increase the average external optical transmittance in the discrete region. In embodiments, the bleaching is achieved by thermally treating the discrete region. Such thermal treatment can be performed using those energy sources known in the art, such as, but not limited to, furnaces, flames such as gas flames, resistance furnaces, lasers, microwaves, or the like. Laser bleaching has been determined to provide substrates with discrete regions having increased average external optical transmittance after the bleaching and can provide greater resolution of bleached regions.

Referring again to aspects of the method 500 of bleaching the glass-ceramic article, the beam of the laser can be directed into the first portion of the bulk using a plurality of laser parameters. In embodiments, the directing the beam from the laser comprises directing a focused beam within the thickness of the bulk to form the first aperture therein. It is contemplated that the glass-ceramic article can be of standardized dimensions such that the beam from the laser can be focused in a calibration step prior to initiation of the method 500. The directing the beam from the laser in embodiments can comprise directing a defocused beam through the thickness of the bulk to form the first aperture therein. In such embodiments, the focus of the beam can be in front or behind the bulk so that a defocused portion of the beam passes through the thickness of the bulk. The directing the beam from the laser in embodiments can comprise directing a collimated beam through the thickness of the bulk to form the aperture therein. It will be appreciated that any one or more of the focused beam, the defocused beam, the collimated beam, and other beam configurations can be directed into the thickness of the bulk to form the aperture therein.

Though higher transmittance in the first aperture can be achieved by heating the first portion of the bulk to the dissolution temperature so as to substantially and/or completely dissolve the crystals via the laser beam, it has been observed that heating the first portion of the bulk above or substantially above the dissolution temperature may result in defects, such as a micro-bubble, within the first aperture. To mitigate formation of such defects, in embodiments, the directing the beam from the laser comprises adjusting a focus of the beam so as to not exceed a maximum temperature within the first portion of the bulk during the irradiating. In embodiments, the adjusting the focus of the beam comprises defocusing the beam so as to not exceed the maximum temperature. In embodiments, the maximum temperature is the dissolution temperature or, if the dissolution temperature is a range, the maximum temperature is a maximum end point of the range of dissolution temperatures. In embodiments, the maximum temperature is 1,100° C., or 1,125° C., or 1,150° C., or 1,175° C., or 1,200° C., or 1,250° C., or 1,300° C., or 1,500° C., or 1,600° C.

In embodiments, the directing the beam from the laser comprises translating or moving at least one of the glass-ceramic article and the laser or the laser beam to form the first aperture. The translation or movement can include vertical translation, horizontal translation, or combinations thereof to alter the position of the beam relative to the glass-ceramic article.

In embodiments, the laser parameters further comprise one or more of a laser power, a beam spot size, and a beam exposure time. In an exemplary embodiment, the laser is a mid-IR laser configured to emit a beam with a wavelength in a range of from about 2.6 μm to about 2.75 μm. The Cr:ZnSe/S mid-IR laser from IPG Photonics may be used for the method disclosed herein. In the exemplary embodiment, the laser parameters are configured to form the first aperture with a target diameter in a range of from about 2 mm to about 3 mm. The laser power in the exemplary embodiment is in a range of from about 12.5 W to about 45.0 W, or from about 15.0 W to about 42.0 W, or from about 17.5 W to about 39.0 W, or from about 20.0 W to about 36.0 W, or from about 22.5 W to about 33.0 W, or from about 25.0 W to about 30.0. W, and also comprising all sub-ranges and sub-values between these range endpoints.

The beam spot size in the exemplary embodiment is in a range of from about 0.20 mm to about 1.50 mm, or from about 0.24 mm to about 1.40 mm, or from about 0.28 mm to about 1.30 mm, or from about 0.32 mm to about 1.20 mm, or from about 0.36 mm to about 1.10 mm, or from about 0.40 mm to about 1.00 mm, or from about 0.44 mm to about 0.90 mm, or from about 0.48 mm to about 0.80 mm, and also comprising all sub-ranges and sub-values between these range endpoints. The beam exposure time in the exemplary embodiment is in a range of from about 0.70 s to about 12.0 s, or from about 0.84 s to about 11.2 s, or from about 0.98 s to about 10.4 s, or from about 1.12 s to about 9.6 s, or from about 1.26 s to about 8.8 s, or from about 1.4 s to about 8.0 s, or from about 1.54 s to about 7.2 s, or from about 1.68 s to about 6.4 s, and also comprising all sub-ranges and sub-values between these range endpoints.

Referring again to FIG. 2, the method 500 comprises determining whether or not to form an additional aperture, such as a duplicate of the first bleached region 36 (e.g., the duplicate first bleached region 39) and/or a duplicate of the second bleached region 37 (e.g., the duplicate second bleached region 40), in the glass-ceramic article. (Block 512). If an additional aperture is to be formed, the irradiating further comprises irradiating a second portion of the bulk by directing the beam from the laser into the thickness of the bulk to heat the second portion and form a second aperture therein. (Block 508, repeated). After the irradiating the second portion of the bulk, the second aperture has a second transmittance that is greater or higher than the bulk transmittance at the first wavelengths or the other ranges. In embodiments in which the second aperture is configured as a substantial duplicate of the first aperture, the second transmittance substantially corresponds to and/or equals the first transmittance. In other embodiments, the second aperture can differ from the first aperture with respect to any attribute of the first aperture. For instance, the second aperture can differ from the first aperture with respect to transmittance, diameter and/or any attribute relating to size, cross sectional shape, extent formed through the thickness (e.g., entirely or partially through the thickness), angle of extent relative to the thickness, etc.

In embodiments, the irradiating the first portion of the bulk to form the first aperture and the irradiating the second portion of the bulk to form the second aperture occur sequentially with a dwell time therebetween. The dwell time can be configured to improve stress distribution and reduce variation between the first aperture and the second aperture and any further apertures if so desired. The dwell time in embodiments can be configured as a relatively long dwell time to allow the bulk to return to the preheat temperature prior to the irradiating the next portion of the bulk to form the next aperture. For instance, after the irradiating the first portion of the bulk to form the first aperture, the method 500 can include a dwell time of at least 10 s, or at least 15 s, or at least 20 s, or at least 30 s, or at least 40 s, or at least 60 s, or any longer dwell time before the irradiating the second portion of the bulk to form the second aperture. The dwell time can be configured as a relatively short dwell time, for example, less than 5 s, in embodiments. In embodiments, the dwell time can be essentially zero such that the irradiating the second portion of the bulk to form the second aperture occurs immediately after the first aperture is formed.

In embodiments, the irradiating the first portion of the bulk to form the first aperture and the irradiating the second portion of the bulk to form the second aperture occur substantially simultaneously. In such embodiments, the beam from the laser comprises at least two beam portions with a first beam portion and a second beam portion configured to irradiate the first portion of the bulk and the second portion of the bulk, respectively. In embodiments, the beam from the laser comprises a plurality of beam portions corresponding in number to the number of apertures to be formed substantially simultaneously in the bulk. The beam from the laser can be configured to be split or otherwise distributed to form the plurality of beam portions. Additionally, or alternatively, multiple beams from multiple lasers can be used to form some or all of the apertures to be formed substantially simultaneously.

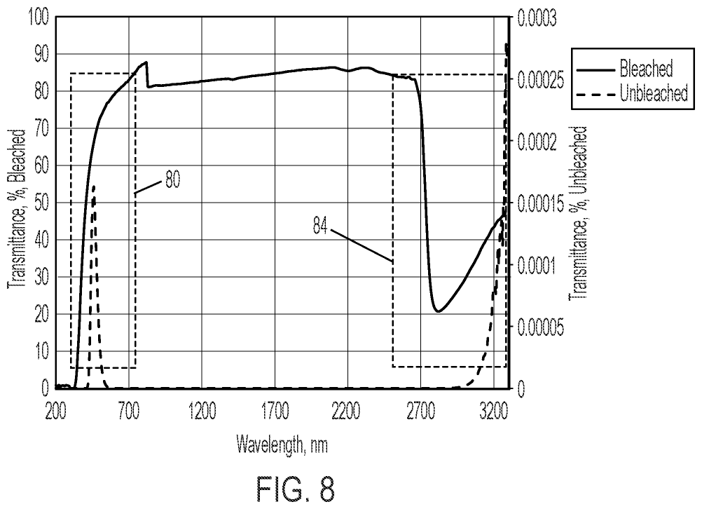

With reference to FIG. 6, the method 500 in embodiments can comprise contacting a first heatsink portion 304 to a first surface 14 of the bulk 42 of the glass-ceramic article 10 that is configured to be irradiated by the beam from the laser. The first heatsink portion 304 is configured to define respective first thru holes 306 through which the beam from the laser is directed or passes to form the first aperture 36, the second aperture 37, and/or any additional apertures (e.g., the duplicate of the second aperture 40) in the bulk. The method 500 in embodiments can further comprise contacting a second heatsink portion 308 to a second surface 18 of the bulk 42 that is opposite the first surface 14 such that the first heatsink portion 304 and the second heatsink portion 308 surround or sandwich the bulk 42 therebetween. In embodiments, the second heatsink portion 308 is configured to define respective second thru holes 310 through which the beam from the laser is directed or passes to form the first aperture 36, the second aperture 37, and/or any additional apertures in the bulk. The first thru holes 306 and the second thru holes 310 can be the same size and/or a different size than the corresponding adjacent apertures that formed by the beam directed and/or passing therethrough. The first heatsink portion 304 and/or the second heatsink portion 308 are configured to enable a substantially uniform temperature across the glass-ceramic article during the irradiating. Such temperature uniformity can be beneficial to improve stress distribution and reduce variation between the first aperture and the second aperture and any further apertures if so desired. In embodiments, the first heatsink portion 304 and/or the second heatsink portion 308 can have a gap with the respective surfaces 14, 18 of the glass-ceramic article, for example, in a range from about 100 μm to about 1,000 μm. The heatsink portions 304, 308 spaced from the surfaces 14, 18 of the glass-ceramic article enable the temperature of the glass to be closer to a set point of the stage temperature and does not decrease the local temperature of the glass directly exposed to the laser during bleaching.

It has been observed that laser bleaching of the glass-ceramic articles described herein can result in the swelling of the glass exposed to the laser beam due to the heating and in-turn the expansion of the material of the glass-ceramic article. Furthermore, the rapid cooling that can take place after the bleaching can result in the bleached region having a higher fictive temperature than the surrounding unbleached material, potentially leading to complex stresses within the article. To alleviate these stresses, an annealing step is preferred. A greater understanding of the crystallization and development of optical absorbance in the glass-ceramic articles disclosed herein has enabled the development of advantaged annealing cycles that provide greater preservation of the optical transparency of the bleached region. The advantaged annealing cycles also enable controlled tuning or reduction of the optical transparency of the bleached region and/or complete reversal of the laser bleaching altogether.

Referring again to FIG. 5, once it is determined that no additional apertures are to be formed (Block 512), the method 500 further comprises determining whether or not to reduce the transmittance of the one or more apertures formed in the prior steps (Block 516). If the transmittance of the one or more apertures in the glass-ceramic article is not to be reduced, the method 500 further comprises annealing the glass-ceramic article by heating the glass-ceramic article to an annealing temperature that is outside of a threshold temperature so as to substantially maintain the first transmittance. (Block 520). As used herein, the term “threshold temperature” refers to a temperature range within which partial reduction of crystals formed during the ceram cycle, such as stoichiometric tungsten oxide, and subsequent intercalation of alkali cations into these crystals occurs during cooling over the temperature range. The determination of threshold temperature is illustrated in connection with Example 3 discussed later in this disclosure. In embodiments, the threshold temperature is in a range of from greater than about 460° C. to about 500° C., or from about 450° C. to about 510° C., or from about 440° C. to about 520° C., or from greater than 460° C. to about 550° C., or from about 430° C. to about 575° C., and also comprising all sub-ranges and sub-values between these range endpoints.

When annealing at an annealing temperature that is outside of the threshold temperature, the glass-ceramic article can be subjected to different annealing cycles. An evaluation of different annealing cycles is described in connection with Example 3 discussed later in this disclosure. The annealing according to one example annealing cycle comprises holding the annealing temperature for a first duration, such as approximately 12 hours, and then rapidly cooling the glass-ceramic article from the annealing temperature to room temperature at a cooling rate, for example in a range from about 50° C. per second to about 100° C. per second, that is substantially greater than furnace rate.

In embodiments, the annealing temperature can comprise a first annealing temperature and a second annealing temperature that is greater than the first annealing temperature. The annealing according to another example annealing cycle comprises heating the first aperture to the first annealing temperature, heating the bulk to the second annealing temperature, gradually cooling the bulk to the first annealing temperature, and rapidly cooling the first aperture and the bulk from the first annealing temperature to room temperature at a cooling rate that is substantially greater than furnace rate. In embodiments, the heating the bulk to the second annealing temperature can comprise using a heater plate to heat the bulk. The heater plate can be configured to define at least one thru hole that aligns with the first aperture. In embodiments, the heating the bulk to the second annealing temperature can comprise using a mid-IR heater to heat the bulk. In embodiments in which the first aperture and the bulk are heated to different temperature during the annealing, the first aperture can be actively cooled via one or more of conduction and convection during the heating the bulk to the second annealing temperature.

In embodiments in which the annealing temperature is outside of the threshold temperature, the first transmittance is reduced by less than 2%/mm, less than 3%/mm, less than 4%/mm, less than 5%/mm, less than 6%/mm, less than 7%/mm, less than 8%/mm, less than 9%/mm, or less than 10%/mm after the annealing.

Referring again to FIG. 5, if the transmittance of the one or more apertures in the glass-ceramic article is to be reduced, the method 500 further comprises annealing the glass-ceramic article by heating the glass-ceramic article to an annealing temperature that is within or passes through the threshold temperature so as to reduce the first transmittance. (Block 524). In one example in which the annealing cycle is configured to reduce the first transmittance, the annealing comprises setting the annealing temperature to the threshold temperature for a duration so as to reduce the first transmittance. In another example in which the annealing cycle is configured to reduce the first transmittance, the annealing comprises setting the annealing temperature to gradually pass through the threshold temperature so as to reduce the first transmittance.

In embodiments in which the annealing temperature is within or passes through the threshold temperature, the first transmittance is reduced by at least 5%/mm, at least 10%/mm, at least 15%/mm, at least 20%/mm, at least 25%/mm, or at least 30%/mm, and/or by no more than about 40%/mm, no more than about 50%/mm, no more than about 60%/mm, no more than about 70%/mm, or nor more than about 80%/mm.

In embodiments, the annealing is performed during the irradiating, after the irradiating, or partially during the irradiating and partially after the irradiating.

In embodiments, the first transmittance of the first aperture is selectable between about 1% greater than the bulk transmittance and a transmittance of about 91%/mm at the first wavelengths via the irradiating and the annealing. In one example, the irradiating is configured to form the first aperture with the selected first transmittance and the annealing is configured to substantially preserve the selected first transmittance. In another example, the irradiating is configured to form the first aperture with an intermediate transmittance that is higher than the first transmittance and the annealing is configured to reduce the intermediate transmittance to the selected first transmittance. The second transmittance of the second aperture is selectable in the same manner as the first transmittance is selectable, as described herein.

After the annealing, the glass-ceramic article may undergo a finishing step to remove the protrusions 58 (FIGS. 2 and 3), if present, and to improve surface quality.

After annealing, the bleached article can subsequently be chemically strengthened by ion exchange. The bleached article can be ion exchanged in a molten salt bath comprising mixtures of lithium nitrate, sodium nitrate, and potassium nitrate between a temperature of 360 and 450° C. for between 0.25 and 25 hours. In embodiments, the ion exchange bath is substantially free of lithium nitrate. In embodiments, the ion exchange bath can also contain silicic acid, sodium nitrite, potassium nitrite, silver nitrate, or mixtures thereof. For example, after bleaching the part can be immersed in a salt bath comprising 80 wt % potassium nitrate, 19.9% sodium nitrate, and 0.1% silicic acid at a temperature of 390° C. for 8 hours to strengthen the part and increase its scratch resistance.

Non-limiting compositions of glass-ceramic materials that are bleachable and provide optical stability according to the principles of the disclosure are listed below in Table 1. In particular, Table 1 lists various mixed molybdenum-tungsten glass-ceramic compositions (Samples 1-35) that each include a combination of WO₃ and MoO₃, among other constituents, which are reported in mol %. According to implementations of the disclosure, these compositions include specific dopant levels and ratios to achieve a tunable local transmittance contrast. These compositions are bleachable and provide optical stability (i.e., retained transmittance) subsequent to heat treatment such as from annealing and/or chemical strengthening via ion exchange.

TABLE 1

| Composition | | | | | | | | | |
|---|---|---|---|---|---|---|---|---|---|
| (mol %) | 1 | 2 | 3 | 4 | 5 | 6 | 7 | 8 | 9 |
| SiO₂ | 62.402 | 62.442 | 62.482 | 62.472 | 62.542 | 62.612 | 62.465 | 62.276 | 62.524 |
| Al₂O₃ | 10.827 | 10.827 | 10.827 | 10.827 | 10.827 | 10.827 | 10.827 | 10.827 | 10.827 |
| B₂O₃ | 9.376 | 9.376 | 9.376 | 9.376 | 9.376 | 9.376 | 9.376 | 9.376 | 9.376 |
| Li₂O | 5.851 | 5.851 | 5.851 | 5.781 | 5.711 | 5.641 | 5.851 | 5.851 | 5.641 |
| Na₂O* | 4.906 | 4.906 | 4.906 | 4.906 | 4.906 | 4.906 | 4.906 | 4.906 | 4.906 |
| SnO₂ | 0.250 | 0.250 | 0.250 | 0.250 | 0.250 | 0.250 | 0.250 | 0.250 | 0.250 |
| WO₃ | 6.100 | 6.100 | 6.100 | 6.100 | 6.100 | 6.100 | 6.100 | 6.100 | 6.100 |
| CaO | 0.126 | 0.126 | 0.126 | 0.126 | 0.126 | 0.126 | 0.063 | 0.252 | 0.126 |
| MoO₃ | 0.163 | 0.122 | 0.082 | 0.163 | 0.163 | 0.163 | 0.163 | 0.163 | 0.250 |
| TOTAL | 100.0 | 100.0 | 100.0 | 100.0 | 100.0 | 100.0 | 100.0 | 100.0 | 100.0 |
| R₂O—Al₂O₃ | −0.070 | −0.070 | −0.070 | −0.140 | −0.210 | −0.280 | −0.070 | −0.070 | −0.280 |
| Composition | | | | | | | | | |
| (mol %) | 10 | 11 | 12 | 13 | 14 | 15 | 16 | 17 | 18 |
| SiO₂ | 62.637 | 62.662 | 62.675 | 62.706 | 62.712 | 62.812 | 62.772 | 62.612 | 62.637 |
| Al₂O₃ | 10.827 | 10.827 | 10.827 | 10.827 | 10.827 | 10.827 | 10.827 | 10.827 | 10.827 |
| B₂O₃ | 9.376 | 9.376 | 9.376 | 9.376 | 9.376 | 9.376 | 9.376 | 9.376 | 9.376 |
| Li₂O | 5.640 | 5.640 | 5.640 | 5.640 | 5.640 | 5.640 | 5.640 | 5.640 | 5.640 |
| Na₂O* | 4.907 | 4.907 | 4.907 | 4.907 | 4.907 | 4.907 | 4.907 | 4.907 | 4.907 |
| SnO₂ | 0.225 | 0.200 | 0.250 | 0.250 | 0.250 | 0.250 | 0.200 | 0.225 | 0.200 |
| WO₃ | 6.100 | 6.100 | 6.100 | 6.100 | 6.000 | 5.900 | 6.100 | 6.100 | 6.100 |
| CaO | 0.126 | 0.126 | 0.063 | 0.032 | 0.126 | 0.126 | 0.032 | 0.063 | 0.063 |
| MoO₃ | 0.163 | 0.163 | 0.163 | 0.163 | 0.163 | 0.163 | 0.146 | 0.250 | 0.250 |
| TOTAL | 100.0 | 100.0 | 100.0 | 100.0 | 100.0 | 100.0 | 100.0 | 100.0 | 100.0 |
| R₂O—Al₂O₃ | −0.280 | −0.280 | −0.280 | −0.280 | −0.280 | −0.280 | −0.280 | −0.280 | −0.280 |
| Composition | | | | | | | | | |
| (mol % | 19 | 20 | 21 | 22 | 23 | 24 | 25 | 26 | 27 |
| SiO₂ | 62.682 | 62.752 | 62.822 | 62.594 | 62.664 | 62.734 | 62.647 | 62.710 | 62.797 |
| Al₂O₃ | 10.827 | 10.827 | 10.827 | 10.827 | 10.827 | 10.827 | 10.827 | 10.827 | 10.827 |
| B₂O₃ | 9.376 | 9.376 | 9.376 | 9.376 | 9.376 | 9.376 | 9.376 | 9.376 | 9.376 |
| Li₂O | 5.570 | 5.500 | 5.430 | 5.570 | 5.500 | 5.430 | 5.430 | 5.430 | 5.430 |
| Na₂O* | 4.907 | 4.907 | 4.907 | 4.907 | 4.907 | 4.907 | 4.907 | 4.907 | 4.907 |
| SnO₂ | 0.250 | 0.250 | 0.250 | 0.250 | 0.250 | 0.250 | 0.250 | 0.250 | 0.250 |
| WO₃ | 6.100 | 6.100 | 6.100 | 6.100 | 6.100 | 6.100 | 6.100 | 6.100 | 6.100 |
| CaO | 0.126 | 0.126 | 0.126 | 0.126 | 0.126 | 0.126 | 0.126 | 0.063 | 0.063 |
| MoO₃ | 0.163 | 0.163 | 0.163 | 0.250 | 0.250 | 0.250 | 0.338 | 0.338 | 0.250 |
| TOTAL | 100.0 | 100 | 100 | 100 | 100 | 100 | 100 | 100 | 100 |
| R₂O—Al₂O₃ | −0.350 | 0.420 | −0.490 | −0.350 | −0.420 | −0.490 | 0.490 | −0.490 | −0.490 |

| Composition | | | | | | | | |
|---|---|---|---|---|---|---|---|---|
| (mol %) | 28 | 29 | 30 | 31 | 32 | 33 | 34 | 35 |
| SiO₂ | 62.402 | 62.612 | 62.822 | 62.738 | 62.912 | 63.212 | 62.662 | 63.130 |
| Al₂O₃ | 10.827 | 10.827 | 10.827 | 10.827 | 10.827 | 10.827 | 10.827 | 10.827 |
| B₂O₃ | 9.376 | 9.376 | 9.376 | 9.376 | 9.376 | 9.376 | 9.376 | 9.376 |
| Li₂O | 0.000 | 0.000 | 0.000 | 0.000 | 0.000 | 0.000 | 0.000 | 0.000 |
| Na₂O* | 10.757 | 10.547 | 10.337 | 10.547 | 10.547 | 10.547 | 10.547 | 10.547 |
| SnO₂ | 0.250 | 0.250 | 0.250 | 0.250 | 0.250 | 0.250 | 0.200 | 0.200 |
| WO₃ | 6.100 | 6.100 | 6.100 | 6.100 | 5.800 | 5.500 | 6.100 | 5.800 |
| CaO | 0.163 | 0.163 | 0.163 | 0.163 | 0.163 | 0.163 | 0.163 | 0.120 |
| MoO₃ | 0.126 | 0.126 | 0.126 | 0.000 | 0.126 | 0.126 | 0.126 | 0.000 |
| TOTAL | 100.0 | 100.0 | 100.0 | 100.0 | 100.0 | 100.0 | 100.0 | 100.0 |
| R₂O—Al₂O₃ | −0.070 | −0.280 | −0.490 | −0.280 | −0.280 | −0.280 | −0.280 | −0.280 |

*Sodium Nitrate and Sodium Carbonate Combined

The bleachable, high-contrast ratio glass-ceramic compositions disclosed in Table 1 achieve high absorbance across the ultraviolet (UV), visible (VIS), and near infrared (NIR) wavelength regimes (e.g., high OD≈5 or greater at a thickness of 1 mm) prior to bleaching and simultaneously remain transparent after bleaching and during annealing with the appropriate conditions, as described throughout this disclosure.

The bleachable, high-contrast ratio glass-ceramic compositions disclosed in Table 1 enable the fabrication of glass-ceramic articles that have one or more highly transparent regions or “apertures” bleached into a monolithic substrate or “bulk” that is highly opaque at visible and near infrared (NIR) wavelengths. The bleached region or aperture in embodiments can have a transmittance of at least 60%/mm at wavelengths from 500 nm to 1,100 nm, or at wavelengths from 450 nm to 1,500 nm, or at wavelengths from 450 nm to 1,750 nm, or at wavelengths from 400 nm to 1,900 nm, or at wavelengths from 350 nm to 2,500 nm (i.e., across the entire visible and NIR spectrum). The bleached region in embodiments can have a transmittance of at least 70%/mm at wavelengths from 500 nm to 1,100 nm, or at wavelengths from 450 nm to 1,500 nm, or at wavelengths from 450 nm to 1,750 nm, or at wavelengths from 400 nm to 1,900 nm, or at wavelengths from 400 nm to 2,400 nm, or at wavelengths from 350 nm to 2,500 nm. The bleached region in embodiments can have a transmittance of at least 80%/mm at wavelengths from 500 nm to 1,100 nm, or at wavelengths from 450 nm to 1,500 nm, or at wavelengths from 450 nm to 1,750 nm, or at wavelengths from 425 nm to 1,900 nm, or at wavelengths from 425 nm to 2,400 nm, or at wavelengths from 350 nm to 2,500 nm. The bleached region in embodiments can have a transmittance of at least 85%/mm at wavelengths from 500 nm to 1,100 nm, or at wavelengths from 450 nm to 1,500 nm, or at wavelengths from 450 nm to 1,750 nm, or at wavelengths from 450 nm to 1900 nm, or at wavelengths from 450 nm to 2,400 nm, or at wavelengths from 350 nm to 2,500 nm. The bleached region in embodiments can have a transmittance of at least 90%/mm (or even at least 91%/mm) at wavelengths from 600 nm to 1,100 nm, or at wavelengths from 600 nm to 1,500 nm, or at wavelengths from 600 nm to 1,900 nm, or at wavelengths from 600 nm to 2,400 nm, or at wavelengths from 350 nm to 2,500 nm. The bleached region in embodiments can have a transmittance of at least 85%/mm over at least a 100 nm wide band anywhere between 350 nm and 2,500 nm.

The unbleached region in embodiments can have a transmittance of at most 0.1% (or an absorbance of at least 3) at wavelengths from 500 nm to 1,100 nm, or at wavelengths from 450 nm to 1,500 nm, or at wavelengths from 450 nm to 1,750 nm, or at wavelengths from 400 nm to 1,900 nm, or at wavelengths from 350 nm to 2,500 nm (i.e., across the entire visible and NIR spectrum). The unbleached region in embodiments can have a transmittance of at most 0.01% (or an absorbance of at least 4) at wavelengths from 500 nm to 1,100 nm, or at wavelengths from 450nm to 1,500 nm, or at wavelengths from 450 nm to 1,750 nm, or at wavelengths from 400 nm to 1,900 nm, or at wavelengths from 400 nm to 2,400 nm, or at wavelengths from 350 nm to 2,500 nm. The unbleached region in embodiments can have a transmittance of at most 0.005% (or an absorbance of at least 4.3) at wavelengths from 500 nm to 1,100 nm, or at wavelengths from 450 nm to 1500 nm, or at wavelengths from 450 nm to 1,750 nm, or at wavelengths from 400 nm to 1,900 nm, or at wavelengths from 400 nm to 2,400 nm, or at wavelengths from 350 nm to 2,500 nm. The unbleached region in embodiments can have a transmittance of at most 0.001% (or an absorbance of at least 5) at wavelengths from 500 nm to 1,100 nm, or at wavelengths from 450 nm to 1,500 nm, or at wavelengths from 450 nm to 1,750 nm, or at wavelengths from 425 nm to 1,900 nm, or at wavelengths from 425 nm to 2,400 nm, or at wavelengths from 350 nm to 2,500 nm. The unbleached region in embodiments can have a transmittance of at most 0.001%/mm over at least a 100 nm wide band anywhere between 350 nm and 2,500 nm.

The glass-ceramic composition in an exemplary embodiment comprises: SiO₂ from about 60 mol % to about 70 mol %; Al₂O₃ from about 8 mol % to about 13 mol %; B₂O₃ from about 7 mol % to about 13 mol %; R₂O from about 6 mol % to about 13 mol %, where R₂O is one or more of LizO, Na₂O, K₂O, Rb₂O, Cs₂O; CaO from about 0 mol % to about 0.5 mol %; SnO₂ from about 0.01 mol % to about 1 mol %; WO3 from about 2 mol % to about 9 mol %; and MoO₃ from about 0 mol % to about 2 mol %. In this embodiment, the amount of R₂O minus the amount of Al₂O₃ ranges from about −1 mol % to about 1 mol %. The glass-ceramic composition may contain lower amounts of R₂O (e.g., from about 4 mol % to about 13 mol %) and/or different forms of tin oxide (e.g., tin (II) oxide or tin (IV) oxide) and molybdenum oxide (e.g., molybdenum (IV) oxide or molybdenum (VI) oxide) and still achieve the optical performance described herein.

The glass-ceramic composition in another embodiment comprises: SiO₂ from about 62 mol % to about 64 mol %; Al₂O₃ from about 9 mol % to about 12 mol %; B₂O₃ from about 8.5 mol % to about 11.5 mol %; R₂O from about 8 mol % to about 12 mol %, wherein R₂O is one or more of LizO, Na₂O, K₂O, Rb₂O, Cs₂O; CaO from about 0.01 mol % to about 0.4 mol %; SnO₂ from about 0.05 mol % to about 0.5 mol %; WO₃ from about 4 mol % to about 8 mol %; and MoO₃ from about 0.05 mol % to about 2.5 mol %. In this embodiment, the amount of R₂O minus the amount of Al₂O₃ ranges from about −0.75 mol % to about 0 mol %.

The high-contrast ratio glass-ceramic compositions disclosed in Table 1 differ in that some have lower oxide concentrations of tin, calcium, tungsten, molybdenum, and alkali. Additionally, these compositions have R₂O—Al₂O₃ values below 0, and as low as −0.49 mol %, Without being bound by theory, the negative R₂O—-Al₂O₃ values reduce the amount of available alkali to intercalate into the tungsten crystals. The lower concentration of calcium reduces the concentration of the nucleating phase present in the glass ceramic (where the nucleating phase is believed to be calcium tungstate). The lower concentration of tin reduces the available source of electrons to donate to the tungsten oxide crystals to partially reduce them. The lower concentrations of tungsten and molybdenum reduce the concentration of crystals present. The lower excess alkali (i.e., R₂O—Al₂O₃) controls the range of stoichiometry of the alkali tungsten bronze crystals that can be made, and the rate of their of formation. Moreover, evidence suggests that improved optical stability can be influenced by the alkali cation identity, where the rate of diffusion and intercalation decreases with increasing alkali cation radii (where Li is the fastest followed by Na, K, and then Cs). Thus, further improved optical stability may be achieved by further reducing and/or eliminating Li (e.g., Samples 28-30 in Table 1), as evaluated in connection with Example 4 discussed later in this disclosure. The extent to which the glass-ceramic compositions include dopant cations M other than alkali cations is customizable depending on the desired transmittance scheme. For instance, limiting M to only alkali cations (e.g., Li, Na, K, Rb, Cs) can enable the highest transmittance in the bleached state. If M is mostly alkali and other species (e.g., Sn), the glass-ceramic compositions can produce strong absorbance in the unbleached state and some transmittance in the bleached state (e.g., >50%/mm).

The high-contrast ratio glass-ceramic compositions disclosed in Table 1 are readily bleachable by standard bleaching techniques. In other words, their strong absorbance was eliminated by laser bleaching, resulting in the formation of highly transparent regions with an average visible and NIR transmittance of greater than 85%. However, it was discovered that when the bleached samples formed from these compositions were then subjected to a subsequent heat treatment, such as an annealing step and/or an ion exchange step, their average transmittance diminished to levels less than 85% (i.e., the sample darkened). The laser bleaching technique disclosed herein was developed to prevent the high-contrast glass-ceramic compositions of Table 1 from darkening during subsequent heat treatment.

In addition to the laser bleaching method disclosed herein, the high contrast ratio glass-ceramic compositions of the present disclosure are uniquely configured to achieve high absorbance in the unbleached region (i.e., a transmittance of less than 0.001%/mm in the visible and NIR regimes), high transmittance in the bleached regions (i.e., a transmittance of greater than 85%/mm in the visible and NIR regimes), and optical stability or retained transmittance in the bleached region after subsequent heat treatment (i.e., maintaining a transmittance of greater than 85%/mm in the visible and NIR regimes). As used herein, the term “retained transmittance” refers to the transmittance through a glass-ceramic material after the material has been laser bleached and after the material has been subjected to a subsequent heat treatment such as encountered during annealing and/or chemical strengthening via ion exchange.

The glass-ceramic compositions disclosed in Table 1 achieve a high dynamic range between bleached and unbleached regions as a result of the specific dopant levels and ratios described above. These compositions are bleachable according to the laser bleaching technique disclosed herein so as to provide optical stability (i.e., retained transmittance) subsequent to heat treatment such as from annealing and/or chemical strengthening via ion exchange. The bleached region or aperture in embodiments comprises constituents of the silicate glass phase and the crystalline phase of the glass ceramic but is substantially free of the species of MₓWO₃. As used herein, an aperture that is “substantially free” of the indicated species is an aperture in which the species can be present but in a concentration that is low enough to achieve the specified retained transmission through the aperture.

The bleached region or aperture in embodiments can have a retained transmittance of at least 50%/mm at wavelengths from 500 nm to 1,100 nm, or at wavelengths from 450 nm to 1,500 nm, or at wavelengths from 450 nm to 1,750 nm, or at wavelengths from 400 nm to 1,900 nm, or at wavelengths from 350 nm to 2,500 nm (i.e., across the entire visible and NIR spectrum). The bleached region in embodiments can have a retained transmittance of at least 60%/mm at wavelengths from 500 nm to 1,100 nm, or at wavelengths from 450 nm to 1,500 nm, or at wavelengths from 450nm to 1,750 nm, or at wavelengths from 400 nm to 1900 nm, or at wavelengths from 390 nm to 2500 nm, or at wavelengths from 350 nm to 2,500 nm. The bleached region in embodiments can have a retained transmittance of at least 70%/mm at wavelengths from 500 nm to 1,100 nm, or at wavelengths from 450 nm to 1,500 nm, or at wavelengths from 450 nm to 1,750 nm, or at wavelengths from 400 nm to 1,900 nm, or at wavelengths from 400 nm to 2,400 nm, or at wavelengths from 350 nm to 2,500 nm. The bleached region in embodiments can have a retained transmittance of at least 80%/mm at wavelengths from 500 nm to 1,100 nm, or at wavelengths from 450nm to 1,500 nm, or at wavelengths from 450 nm to 1,750 nm, or at wavelengths from 425 nm to 1,900 nm, or at wavelengths from 425 nm to 2,400 nm, or at wavelengths from 350 nm to 2,500 nm. The bleached region in embodiments can have a retained transmittance of at least 85%/mm at wavelengths from 500 nm to 1,100 nm, or at wavelengths from 450 nm to 1,500 nm, or at wavelengths from 450 nm to 1,750 nm, or at wavelengths from 450 nm to 1,900 nm, or at wavelengths from 450 nm to 2,400 nm, or at wavelengths from 350 nm to 2,500 nm. The bleached region in embodiments can have a retained transmittance of at least 90%/mm at wavelengths from 600 nm to 1,100 nm, or at wavelengths from 600 nm to 1,500 nm, or at wavelengths from 600 nm to 1,900 nm, or at wavelengths from 600 nm to 2,400 nm, or at wavelengths from 350 nm to 2,500 nm. The bleached region in embodiments can have a retained transmittance of at least 85%/mm over at least a 100 nm wide band anywhere between 350 nm and 2,500 nm.

### EXAMPLES

The following examples represent certain non-limiting examples of the composition of the glass-ceramic articles, methods of bleaching the glass-ceramic articles of the present disclosure, and/or experiments to evaluate aspects of the methods disclosed herein.

### Example 1—Preheating

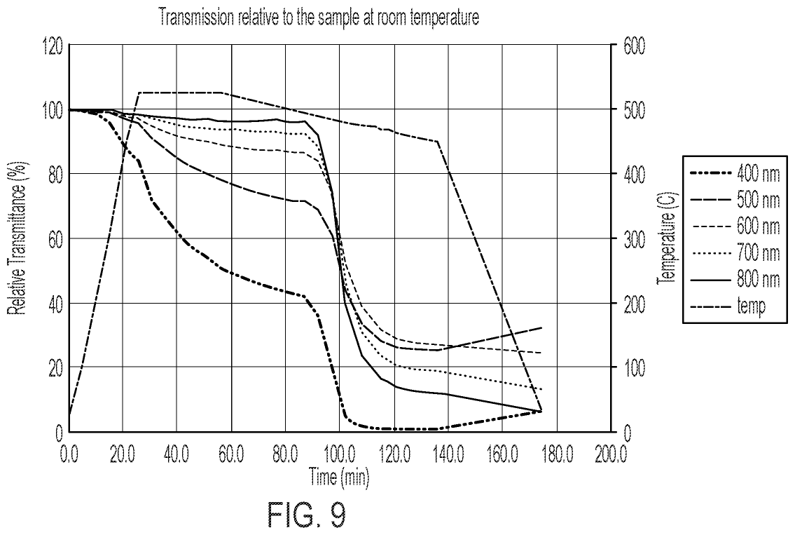

The temperature at which the sample is maintained during laser bleaching (i.e., the preheat temperature) can affect the transparency of the bleached window. FIG. 7 is plot illustrating transmittance at 633 nm for samples depending on the sample stage temperature during laser bleaching. FIG. 7 shows a decrease in the transmittance for temperatures that exceed approximately 480° C.-500° C. when subjected to slow cooling after the laser bleaching. However, with fast cooling/quenching (e.g., approximately 100° C./s after the laser bleaching, the decrease in the transmittance may be less pronounced. It has been observed that this preheat step before laser bleaching may be important to reduce sample failure due to stress buildup. It has also been observed that stress relaxation during bleaching may be enabled upon selection of the appropriate preheat temperature. Therefore, the preheat temperature in an exemplary embodiment is equal to or less than about 600° C., or in a range from about 100° C. to about 600° C.

### Example 2—Irradiating and Bleaching Wavelength

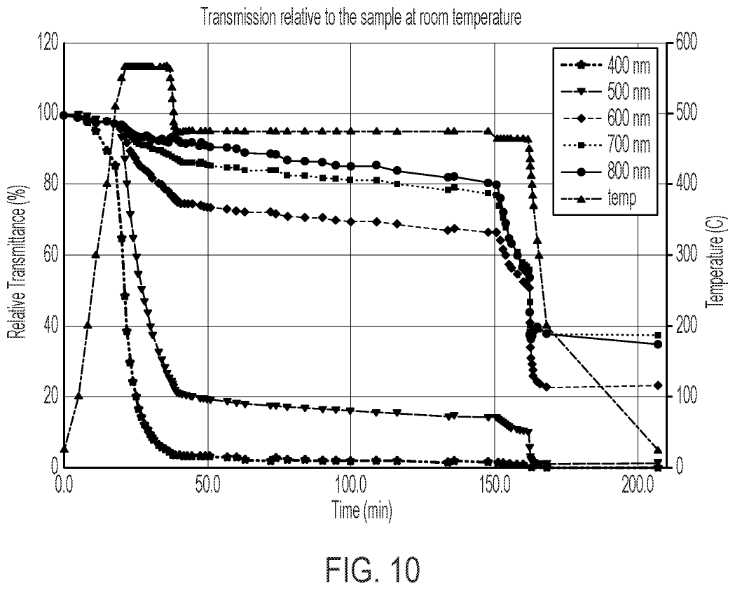

As described previously, bleaching results in a significant drop in absorption as the alkali deintercalate from the crystals, especially in the wavelength band from about 800 nm to about 2,600 nm. If the laser works in this wavelength range, absorption drops relatively quickly to very low levels inhibiting heating the irradiated area to sufficiently high temperature (e.g., the dissolution temperature) to dissolve the tungsten bronze crystals. In order to heat the volume to the dissolution temperature, residual absorption in (and approaching) the bleached state at the laser wavelength is desirable. FIG. 8 illustrates this concept.

FIG. 8 is a plot of the transmittance of the unbleached and bleached glass ceramic of a sample with regions of the plot enclosed by the two rectangular boxes in dotted line type indicating the location of the preferred laser wavelengths for bleaching. As shown in FIG. 8, the rectangular box 80 is indicative of a first laser wavelength band within which residual absorption is present, and rectangular box 84 is indicative of a second laser wavelength band within which residual absorption is present. From practical considerations, the residual absorption, in terms of transmittance, is preferably between 5%/mm transmittance and 85%/mm transmittance. Thus, the rectangular box 80 indicates the first laser wavelength band (i.e., a lower laser wavelength band) is in a range of from about 350 nm to about 740 nm, and the rectangular box 84 indicates the second laser wavelength band (i.e., an upper laser wavelength band) is in a range of from about 2,430 nm to about 3,300 nm.

It should be appreciated that the transmittances and corresponding wavelengths plotted in FIG. 8 are approximate and they may vary to some degree for different compositions and with changes in temperature. Thus, for some compositions, the residual absorption, in terms of transmittance, is preferably between a different transmittance range than indicated above, for example, between 10%/mm transmittance and 85%/mm transmittance. For this different transmittance range, the first or lower laser wavelength band is in a range from about 360 nm to about 620 nm and the second or upper laser wavelength band is in a range from about 2,690 nm to about 3,300 nm. In embodiments, the residual absorption, in terms of transmittance, is preferably less than or equal to 70%/mm otherwise complete bleaching may not be attainable with reasonable laser powers. In embodiments, some compositions may have only one laser wavelength band within which sufficient residual absorption exists to provide the necessary heating as discussed earlier.

### Example 3—Annealing and Threshold Temperature

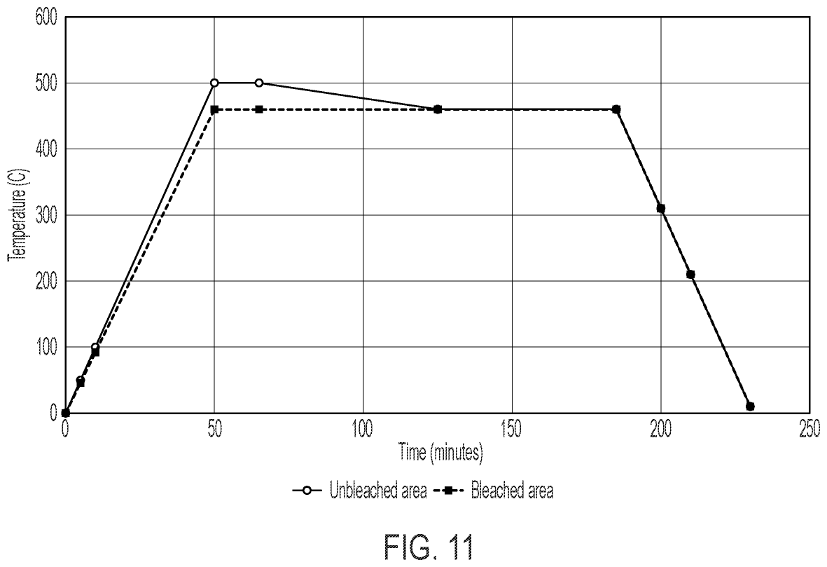

In-situ absorbance measurements made during the formation of crystals in the glass ceramics disclosed herein show that the optical transmittance of these material remains high, and nearly constant during the hold time at the peak temperature of the thermal cycle. Transmittance rapidly decreases during cooling when the material reaches a temperature between 460° C. and 470° C. , as illustrated in FIG. 9. FIG. 9 plots in-situ transmittance measurements of a tungsten glass ceramic sample heated to 525° C. at a ramp rate of 20° C./m, held for 30 minutes, cooled to 450° C. at 1° C./m, and then cooled at furnace rate. The transmittance measurements were made approximately every five minutes during the experiment. As can be observed, when the sample reaches a temperature between 460° C. and 470° C. , the transmittance decreases rapidly.

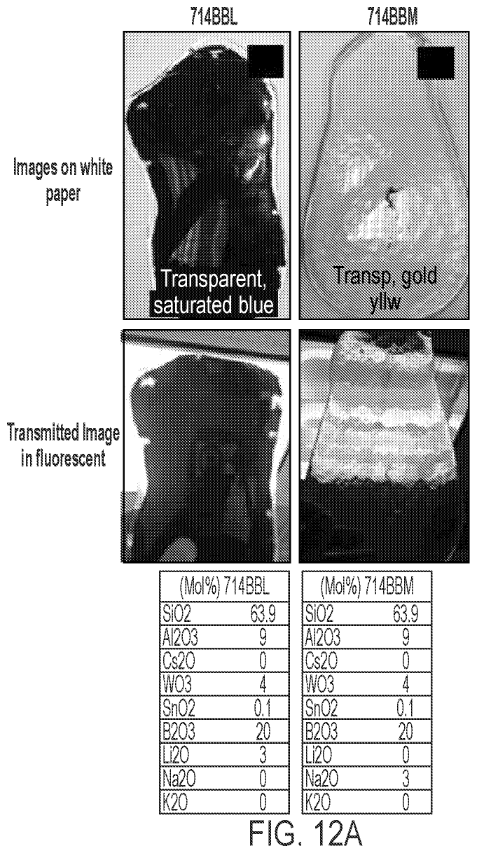

Ex-situ Raman spectra and interpretation of these observations lead to the hypothesis that stoichiometric tungsten oxide is formed during the hold at the peak temperature of the ceram cycle, and that partial reduction of these crystals followed by intercalation of alkali cations occurs during cooling over this narrow temperature range. To further corroborate that this rapid change in transmittance is correlated with a threshold temperature range, additional in-situ optical measurements were collected where the sample was held at a temperature just above this threshold temperature for 1.8 hours and then lowered into the threshold temperature regime. During the prolonged hold time, transmittance changed minimally, until the temperature was lowered into the threshold temperature regime where it is believed alkali intercalate into the crystal, and the transmittance rapidly diminished, as shown in FIG. 10. FIG. 10 plots in-situ transmittance measurements of a tungsten glass ceramic sample heated to a temperature ramped to 565° C. at 30° C./min then held at 565° C. for 15 min. The sample was then cooled to 475° C. rapidly and held for about 1.8 h. The sample was than rapidly cooled to 465° C. and held for 10 min. The heater was then turned off and cooled to room temperature.

It has been observed that if a sample is annealed above the threshold temperature range where the alkali intercalates (e.g., T≥465° C. ), rapid cooling to room temperature through this temperature results less transmittance loss than when cooled more slowly (e.g., furnace rate (2.6° C./m). More significantly, it has been observed if a sample is annealed at temperature just below the threshold temperature regime (e.g., at 460° C. for 12 h), the transparency of the bleached apertures can also be preserved. In contrast, if the sample is annealed at the threshold temperature regime for the same duration of time, the sample significantly darkens. After annealing, the optical retardation per unit thickness in the bleached areas can be <12 nm/mm, or preferably <10 nm/mm.

Annealing (or stress relief) can be accomplished in a furnace as a separate step after the laser bleaching, or as part of the laser bleaching process, or as a combination of the two. For example, stresses may be relieved to some extent by holding the sample on the heating stage (e.g., at 500° C. ) for some duration before unloading and cooling at a fast rate to <=460° C. to avoid darkening in bleached areas.

Additionally, measures may be taken to promote more stress relief in the dark unbleached areas (which can have high tensile stresses) by maintaining these areas at slightly higher temperature than the bleached areas. For example, the bleached areas can be maintained at a temperature slightly below the threshold temperature (e.g., about 460° C.) for some duration and the unbleached areas may be maintained at a temperature above the threshold temperature range (e.g., >470° C.). Such a temperature difference may be promoted by (i) using a heater plate that preferentially heats the unbleached areas, e.g., by having holes corresponding to the bleached areas, or (ii) by using a mid-IR heater that preferentially heats the unbleached areas. In both cases, the bleached areas may be actively cooled through conduction (e.g., colder metal prongs touching the bleached apertures) or convection (blowing cooling fluid such as air on to the bleached areas) to prevent the bleached areas from heating up due to conduction within the sample.

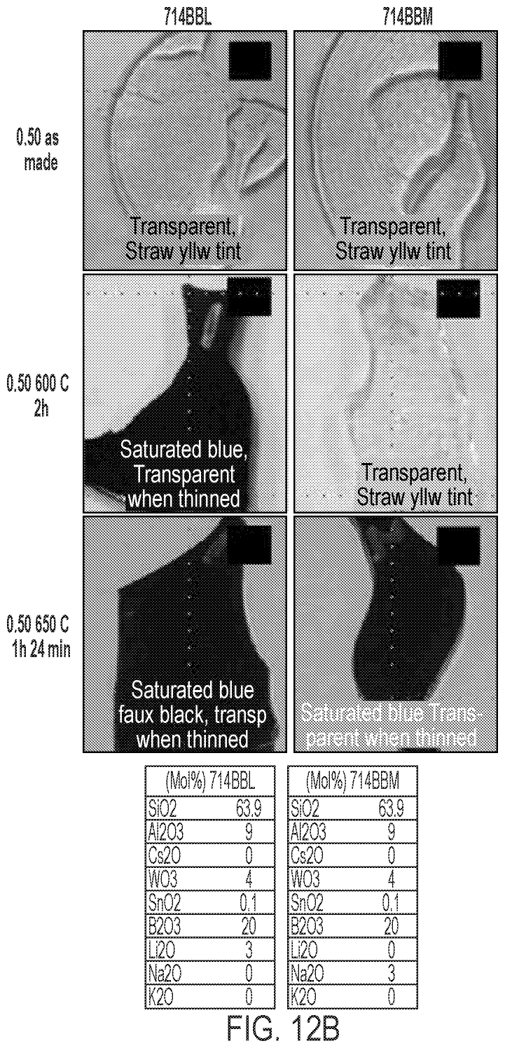

Next, the unbleached area can be gradually cooled to the same temperature as the bleached areas and held there for some duration for further stress relief before cooling the whole sample to room temperature, as shown in FIG. 11. FIG. 11 plots temperature versus time to illustrate how the bleached areas can be selectively cooled during annealing relative to the unbleached area to enable stress alleviation without re-darkening of the bleached areas. Such a thermal treatment may be done either immediately after laser bleaching (e.g., without cooling the sample to room temperature) or in a subsequent annealing step.

In embodiments, the bleached areas can be subsequently heated preferentially (e.g., with lasers) to temperatures above the alkali intercalation temperature to reduce the fictive temperature differences between the bleached and unbleached areas, and to relieve stresses. A potential advantage versus heating the entire sample is that faster cooling of the bleached areas may be achievable.

In embodiments, annealing time and temperature can be adjusted to achieve different colors in the bleached areas. In embodiments, the sample can appear completely dark but reveal a pattern when back lit. The residual birefringence in the bleached window of the part/article (before ion exchange) should be less than approximately 200 nm/mm.

### Example 4—Annealing, Cation Identity, and Crystallization Rate

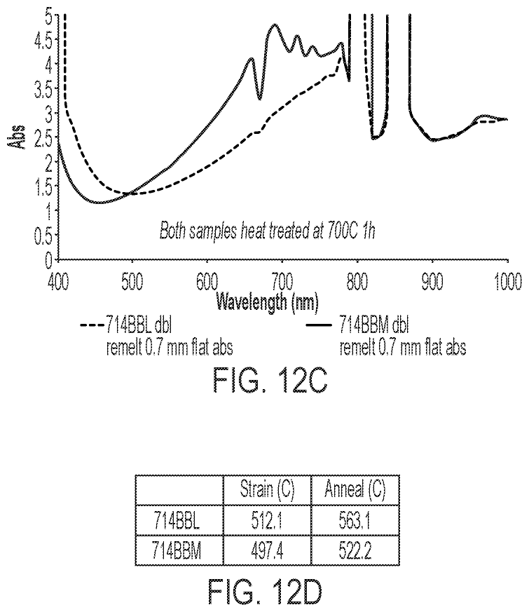

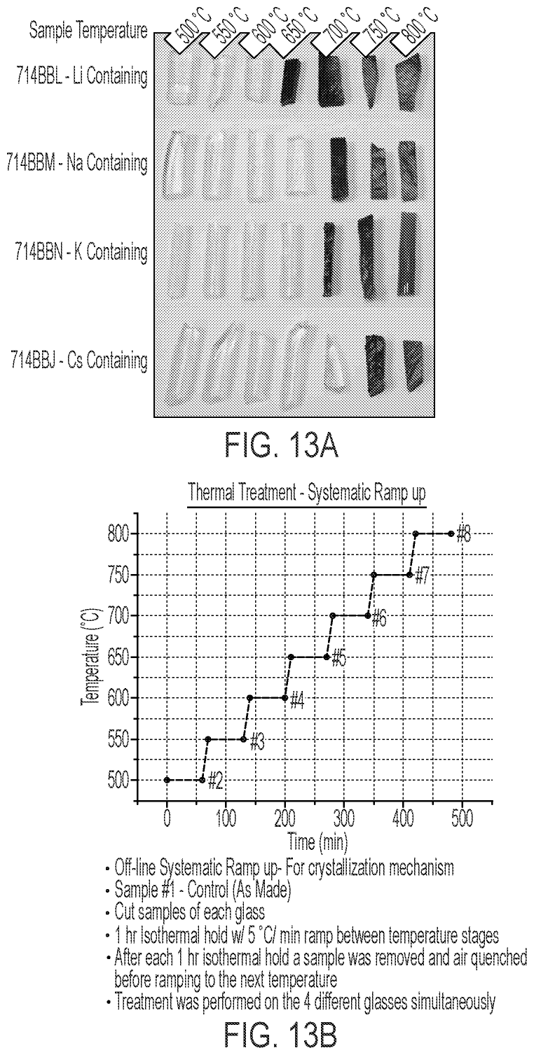

Experiments were performed to evaluate if improved optical stability can be influenced by the alkali cation identity, where the rate of diffusion and intercalation decreases with increasing alkali cation radii (where Li is the fastest followed by Na, K, and then Cs). FIGS. 12 and 13 illustrate these experiments.

FIG. 12A shows images and compositions (as-batched mol %) of annealed patties of glass ceramics 714BBL (made with Li only) and 714BBM (made with Na only) cast onto a steel table and annealed. The Li-containing composition (714BBL) spontaneously crystallized on pouring and turned a dark blue color suggesting that the crystallization rate is higher than the sodium analog (714BBM). Shown in FIG. 12B are images of the splat quenched ˜2 mm thick pieces and subsequent samples of the splat quenched glass that was heat treated at 600 C for 2 h and 650 C for 1 h and 24 minutes. As shown, the Li-containing glass turned color (i.e., crystallized) after a heat treatment at 600 C for 2 h, whereas the sodium analog did not crystallize until being heat treated 50 C hotter. Despite this difference in rates, the optical absorbance was similar, as shown in FIG. 12C. Additionally, this difference in crystallization rate does not appear to be due to a difference in viscosity between the two glasses. Indeed, the Na analog has a lower strain and anneal point (see FIG. 12D), which may suggest diffusion would be occurring faster at a fixed temperature relative to the lithium analog.

FIG. 13A shows images of samples of Li, Na, K, and Cs analogs (glass codes 714BBL, M, N, and J, respectively) heat treated over a range of temperature (500-800 C) in a “stair step” fashion illustrated in FIG. 13B. Despite differences in alkali identity, the annealing temperatures are similar for the Li, Na, K, and Cs analogs: 563.1 C, 522.2 C, 553.7 C, and 566.1 C, respectively. This similarity in annealing temperatures suggest that this difference in crystallization rate is not driven by differences in viscosity, but instead differences in diffusivity and ability for the alkali cations to intercalate into the channels in the crystal (i.e., the smaller the alkali, the easier it can “fit” into the crystal).

### Example 5—Irradiating and Laser Parameters

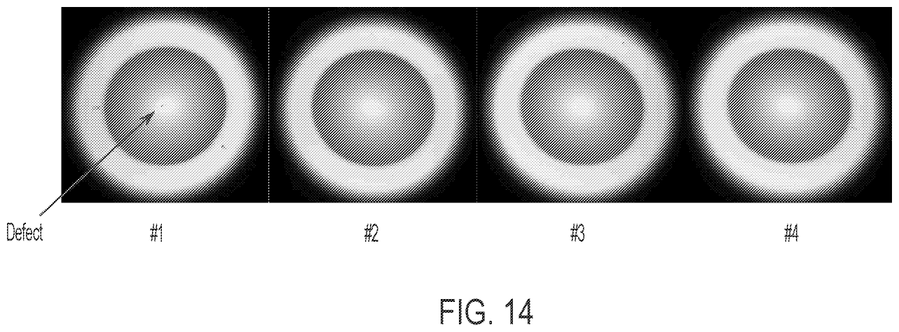

Experiments were performed to evaluate the influence of certain laser parameters. In general, the higher the temperature induced by laser irradiation the better transparency is accomplished by more complete dissolution of the tungsten bronze crystals. However, at temperatures above a certain value, referred to as the “maximum temperature” elsewhere in this disclosure, high tensile stress inside the bleached windows can result in a micro-bubble (a defect) inside the window. This defect can be avoided by defocusing the laser beam and/or by choosing a shorter exposure duration. FIG. 14 illustrates the effect of the laser beam defocusing. FIG. 14 shows four side-by-side photographs of four different bleached windows formed with different beam spot sizes, increasing from a beam spot size of approximately 0.4 mm in photograph #1 by an increment of approximately 10% in each of photographs #2-#4. As shown in FIG. 14, the defect is not visually detectable in photographs #2-#4. In embodiment, the absorption at the laser bleaching wavelength is also a factor in whether or not a defect will be formed during bleaching, and shorter laser wavelengths (e.g., less than approximately 2.72 μm) may help to avoid such defects.

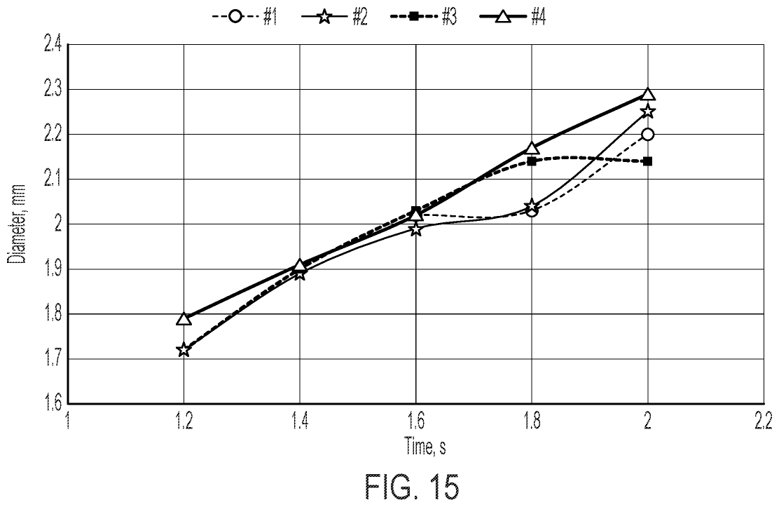

FIG. 15 illustrates the effect of exposure time on bleached window diameter. The experiments were performed by altering the laser beam focusing conditions (#1 through #4, which correspond to the laser beam focusing conditions #1 through #4 in FIG. 14) and at a range of irradiation durations. As shown in FIG. 15, the bleached window diameter is not affected much by the beam spot diameter, but by mostly by the exposure time.

Though some of the laser parameters discussed in this disclosure are configured to form one or more apertures with a target diameter in a range from about 2 mm to about 3 mm, other sizes and configurations of the apertures are contemplated. In embodiments, the target diameter can be in a range from about 2 mm to about 4 mm, or from about 1.5 mm to about 3.5 mm, or from about 0.2 mm to about 2.5 mm, or from about 1 mm to about 4.5 mm, or from about 1 mm to about 5 mm, or a range larger or smaller than those indicated herein. In such embodiments, the laser parameter may be adjusted to form the apertures with the different target diameters. In embodiments, the laser parameters are generally increased (e.g., higher laser power, larger beam spot size, longer exposure time, etc.) to form apertures with target diameters larger than from about 2 mm to about 3 mm. Conversely, the laser parameters are generally decreased (e.g., lower laser power, smaller beam spot size, shorter exposure time, etc.) to form apertures with target diameters smaller than from about 2 mm to about 3 mm.

In embodiments, the laser parameters are fixed or static during the irradiating such that each laser parameter remains substantially the same during the irradiating. In embodiments, the laser parameters are dynamically adjustable (e.g., on the fly) during the irradiating such that each laser parameter can have a plurality of different values and/or settings (e.g., different wavelengths, laser powers, focuses, beam spot sizes, exposure times, etc.) during the irradiating. Such dynamic adjustment can be beneficial to control heating during the irradiating (e.g., to avoid exceeding the maximum temperature) and/or vary the bleaching completeness (e.g., between partial and full bleaching) from aperture to aperture and/or within the same aperture.

### Example 6—Transmittance Measurements

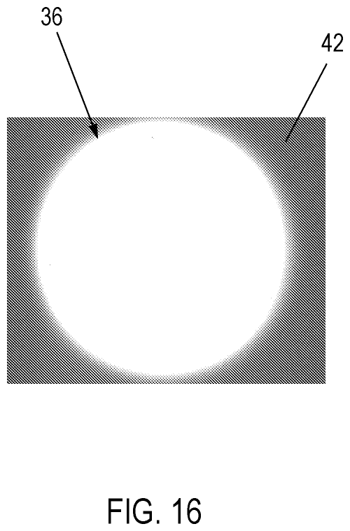

Samples were made and processed according to the principles of the disclosure. Each sample comprised a plate or chip formed from the same bulk glass composition. The length and width of each glass chip were approximately square with a sufficient area to accommodate a pattern of bleached apertures (e.g., from six to twelve apertures per sample). The thickness of the glass chips was in a range of from about 1.0 mm to about 1.1 mm. The apertures 36 formed in each sample were approximately 2-3 mm in diameter. FIG. 16 is a magnified digital image of a top surface of one of the samples showing a single aperture 36 (e.g., bleached region) surrounded by bulk glass 42 (e.g., unbleached region).

The bulk glass composition used for the samples was developed from continued experiments and is similar to the compositions described above. The bulk glass composition used for the samples comprises about 64.96 mol % silicon dioxide, about 10.83 mol % aluminium (III) oxide, about 9.38 mol % boron trioxide, about 5.84 mol % lithium oxide, about 4.69 mol % sodium oxide, about 0.25 mol % tin (II) oxide, about 3.9 mol % tungsten (VI) oxide, and about 0.15 mol % molybdenum (IV) oxide.

The samples were first cerammed according to the following ceram schedule: heating to about 525° C., holding for about 16 hours, cooling to about 425° C. at a rate of about 0.5° C. per minute, and then cooling to about room temperature at furnace rate (e.g., an ambient air electric oven used for heating). After the samples were cerammed, a pattern of apertures was bleached into each sample. A bleaching wavelength was selected from one of the lower laser wavelength band and the upper laser wavelength band, such as described in Example 2. The samples were heated to pre-heat temperature in a range of from about 530° C. to about 590° C. during laser bleaching. After the samples were bleached, the samples were annealed according to the following annealing schedule: heating to about 463.1° C. at a rate of about 3° C. per minute, holding this temperature for about 3.5 hours to 4.5 hours, then cooling at furnace rate (e.g., about 2.6° C. per minute in an ambient air electric oven).

Measurements were made to assess the transmittance through each aperture of each sample over a range of wavelengths from 350 nm to 1000 nm in 1 nm increments. UV-VIS-NIR transmission was measured using an Ocean Optics QE Pro Spectrometer with Small Spot UMA accessory. The modular spectrometer setup included the following parameters: integration time—100 ms (sample spectrometer), 500 ms (reference spectrometer); scans—40(sample spectrometer), 8 (reference spectrometer); electric dark—off; and non-linearity correction—off. The source optics included: Energetiq EQ99 source, coupled to input fiber with 2″, 75 mm FL lens; and 115 μm solarization resistant fiber-coupled to Small Spot UMA. The detector optics included: small spot UMA with 2″ sphere; 1000 μm fiber; and QEPro spectrometer with 25 μm slit. The samples were measured for axial transmission on the small spot UMA accessory relative to an open beam baseline.

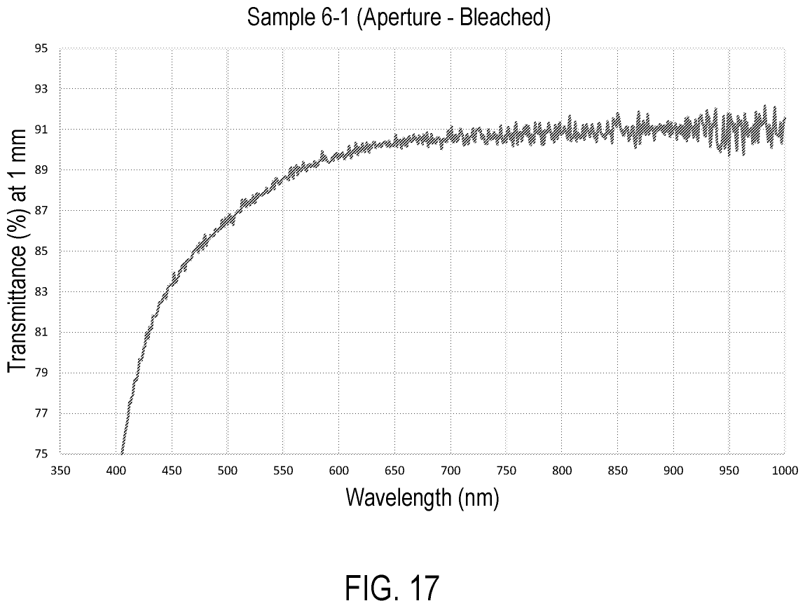

FIG. 17 is a plot of transmittance of a bleached aperture 36 in a sample (hereinafter “Sample 6-1”) prepared in accordance with Example 6 over a range of wavelengths. As shown, Sample 6-1 achieved a transmittance of at least 85%/mm over a band of wavelengths having a width greater than about 500 nm within the measured wavelength range. Sample 6-1 achieves a transmittance of at least 90%/mm over a band of wavelengths having a width greater than about 400 nm within the measured wavelength range. Sample 6-1 achieves a transmittance of at least 91%/mm over a band of wavelengths having a width greater than about 300 nm within the measured wavelength range.

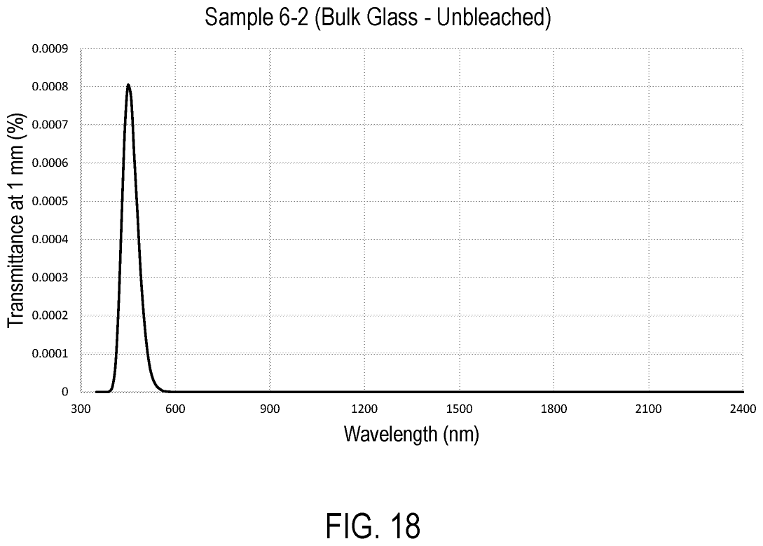

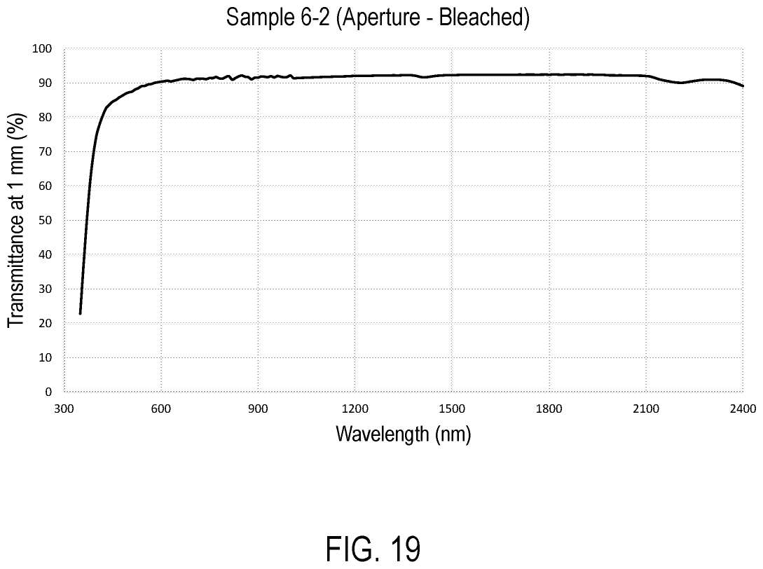

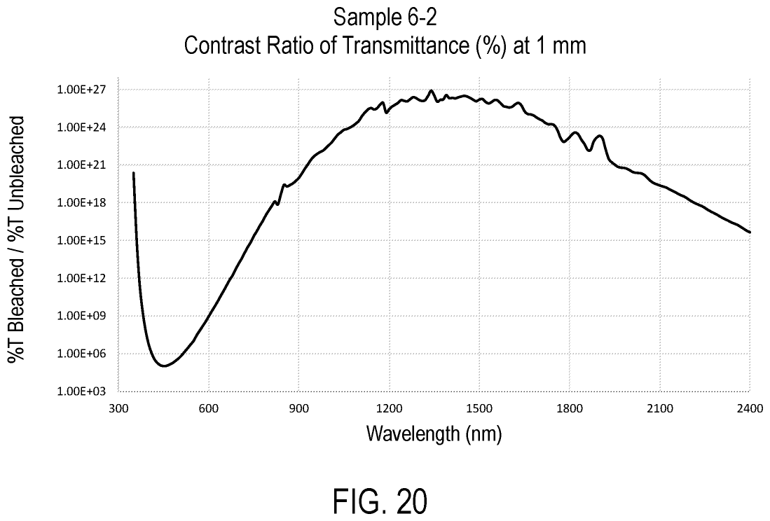

FIG. 18 and FIG. 19 are plots of transmittance of a bulk glass 42 and a bleached aperture 36, respectively, in a sample (hereinafter “Sample 6-2”) prepared in accordance with Example 6 over a range of wavelengths (e.g., 350 nm to 2,400 nm). FIG. 20 is a plot of a ratio of the transmittance of the bleached aperture 36 (FIG. 19) and the transmittance of the bulk glass 42 (FIG. 18) over the same range of wavelengths. As shown in FIG. 20, the ratio between the transmittance of the aperture 36 (e.g., the first transmittance) and the transmittance of the bulk glass 42 (e.g., the bulk transmittance) is at least 1.0×10⁵ within a ratio band that extends for 100 nm between wavelengths from about 350 nm to about 2,500 nm (e.g., where the ratio band is centered about a wavelength of 450 nm). As shown in FIG. 20, the ratio between the transmittance of the aperture 36 (e.g., the first transmittance) and the transmittance of the bulk glass 42 (e.g., the bulk transmittance) is at least 8.0×10²⁶ within a ratio band that extends for 100 nm between wavelengths from about 350 nm to about 2,500 nm (e.g., where the ratio band is centered about a wavelength of 1340 nm).

While the disclosure has been illustrated and described in detail in the drawings and foregoing description, the same should be considered as illustrative and not restrictive in character. It is understood that only the preferred embodiments have been presented and that all changes, modifications, and further applications that come within the spirit of the disclosure are desired to be protected.

1. A method of bleaching a glass-ceramic article, comprising:
irradiating a first portion of a bulk of the glass-ceramic article by directing a beam from a laser into a thickness of the bulk to heat the first portion and form a first aperture therein, the bulk having an amorphous silicate glass phase, a crystalline phase, and a bulk transmittance, the first aperture having a first transmittance that is greater than the bulk transmittance at first wavelengths from 350 nm to 2500 nm, the beam comprising a bleaching wavelength selected from a laser wavelength band within which residual absorption persists in the aperture after the irradiating at the bleaching wavelength.

2. The method of claim 1, wherein the laser wavelength band comprises at least two laser wavelength bands that are nonoverlapping.

3. The method of claim 1, wherein the laser wavelength band comprises a lower laser wavelength band that is adjacent to and/or overlapping a lower end of the first wavelengths.

4. The method of claim 1, wherein the laser wavelength band comprises an upper laser wavelength band that is adjacent to and/or overlapping an upper end of the first wavelengths.

5. The method of claim 1, wherein the residual absorption, in terms of transmittance, persists in the aperture after the irradiating in a range of from about 5%/mm to about 85%/mm within the laser wavelength band.

6. The method of claim 1, wherein the crystalline phase comprises a species of MₓWO₃ where 0<x<1 and where M is an intercalated dopant cation.

7. The method of claim 6, wherein the species of MₓWO₃ corresponds to a primary absorptive species into which the bleaching wavelength couples during the irradiating.

8. The method of claim 7, wherein the bulk comprises a secondary absorptive species into which the bleaching wavelength couples during the irradiating, the secondary absorptive species differing from the primary absorptive species so as to provide the residual absorption.

9. The method of claim 8, wherein the secondary absorptive species comprises one or more of (i) chemical hydroxyl groups, (ii) an ultraviolet (UV) absorption edge of the glass phase, and (iii) a dopant, and wherein the method further comprises doping the bulk with the dopant prior to the irradiating when the secondary absorptive species comprises the dopant.

10. (canceled)

11. (canceled)

12. The method of claim 9, wherein, when the secondary absorptive species comprises the dopant, the dopant comprises one or more of Ce, Er, Tb, Pr, Mn, Ti, Cu, Co, Ni, Fe, Cr, V, Ag, and Au in oxide or metallic form, and wherein the bulk comprises one or more of (i) less than 2.5 mol % of the dopant selected from the group consisting of Ce, Er, Pr. Tb, and combinations thereof and (ii) less than 0.5 mol % of the dopant selected from the group consisting of Mn, Ti, Cu, Co, Ni, Fe, Cr, V, Ag, Au, and combinations thereof.

13. (canceled)

14. (canceled)

15. The method of claim 6, wherein the irradiating is configured to heat the first portion of the bulk to a dissolution temperature in which the species of MₓWO₃ of the crystalline phase substantially dissolves into the bulk, and wherein the dissolution temperature is one or more of (i) greater than the liquidus temperature of the species of MₓWO₃ and (ii) in a range of from about 600° C. to about 1,100° C.

16. (canceled)

17. (canceled)

18. (canceled)

19. (canceled)

20. The method of claim 1, wherein the laser comprises a mid-infrared (IR) laser, and wherein the beam is directed from the mid-IR laser using a plurality of laser parameters, the laser parameters comprising one or more of (i) a laser power in a range of from about 17.5 W to about 39.0 W, (ii) a beam spot size in a range of from about 0.20 mm to about 1.50 mm, and (iii) an exposure time in a range of from about 0.70 s to about 12.0 s.

21. (canceled)

22. (canceled)

23. (canceled)

24. (canceled)

25. (canceled)

26. (canceled)

27. The method of claim 20, wherein the laser parameters are configured to form the first aperture with a target diameter in a range of from about 0.2 mm to about 5 mm.

28. (canceled)

29. The method of claim 1, wherein the irradiating further comprises irradiating a second portion of the bulk by directing the beam from the laser into the thickness of the bulk to heat the second portion and form a second aperture therein, the second aperture spaced from the first aperture and having a second transmittance that is greater than the bulk transmittance at the first wavelengths.

30. (canceled)

31. (canceled)

32. (canceled)

33. (canceled)

34. (canceled)

35. (canceled)

36. The method of claim 1, further comprising preheating the glass-ceramic article prior to the irradiating, the preheating comprising heating the glass-ceramic article to a preheat temperature in a range of from about 100° C. to about 600° C.

37. (canceled)

38. (canceled)

39. (canceled)

40. The method of claim 1, further comprising annealing the glass-ceramic article by heating the glass-ceramic article to an annealing temperature.

41. The method of claim 40, wherein the annealing temperature is outside of a threshold temperature so as to substantially maintain the first transmittance, wherein the annealing further comprises:
holding the annealing temperature for a first duration, and
rapidly cooling the glass-ceramic article from the annealing temperature to room temperature at a cooling rate that is substantially greater than furnace rate, and
wherein the first transmittance is reduced by less than 5%/mm after the annealing.

42. (canceled)

43. The method of claim 40, wherein the annealing temperature comprises a first annealing temperature and a second annealing temperature that is greater than the first annealing temperature, wherein the first annealing temperature and the second annealing temperature are outside of a threshold temperature so as to substantially maintain the first transmittance, wherein the annealing further comprises:
heating the first aperture to the first annealing temperature,
heating the bulk to the second annealing temperature,
gradually cooling the bulk to the first annealing temperature, and
rapidly cooling the first aperture and the bulk from the first annealing temperature to room temperature at a cooling rate that is substantially greater than furnace rate, and
wherein the first transmittance is reduced by less than 5%/mm after the annealing.

44. (canceled)

45. (canceled)

46. (canceled)

47. (canceled)

48. The method of claim 40, wherein the annealing comprises one or more of (i) setting the annealing temperature to a threshold temperature for a duration so as to reduce the first transmittance and (ii) setting the annealing temperature to gradually pass through the threshold temperature so as to reduce the first transmittance, and wherein the first transmittance is reduced by at least 5%/mm after the annealing.

49. (canceled)

50. (canceled)

51. (canceled)

52. The method of claim 40, further comprising ion exchanging the glass-ceramic article in a bath comprising sodium nitrate and/or potassium nitrate between a temperature of 360 and 450° C. for between 0.25 hours and 25 hours.

53. (canceled)

54. (canceled)

55. (canceled)

56. (canceled)

57. (canceled)

58. (canceled)

59. (canceled)

60. (canceled)
